(19) United States
(12) Patent Application Publication
(10) Pub. No.: US 2008/0007766 A1
(43) Pub. Date: Jan. 10, 2008

(54) Image forming device capable of executing workflow

(75) Inventor: Haruna Sasakuma, Osaka (JP)

Correspondence Address: MORRISON & FOERSTER LLP, 1650 TYSONS BOULEVARD, SUITE 400, MCLEAN, VA, 22102, US

(73) Assignee: Konica Minolta Business Technologies, Inc., Tokyo (JP)

(21) Appl. No.: 11/583,168

(22) Filed: Oct. 19, 2006

(30) Foreign Application Priority Data
Jul. 6, 2006 (JP) 2006-187066

(51) Int. Cl. G06F 3/12

(52) U.S. Cl. 358/1.15

(57) ABSTRACT

A workflow including a plurality of steps is registered in MFP. The steps of the workflow are serially executed every time when a registered operation user pressed a workflow key. When any user other than the registered operation user logs-in, the workflow key is not displayed, or displayed in a gray-out fashion.

This application is based on Japanese Patent Application No. 2006-187066 filed with the Japan Patent Office on Jul. 6, 2006, the entire content of which is hereby incorporated by reference.

### BACKGROUND OF THE INVENTION

1. Field of the Invention

The present invention relates to an image forming device, an image forming system, and a method of controlling the image forming device, more specifically to an image forming device capable of executing a workflow, an image forming system, and a method of controlling the image forming device.

2. Description of the Related Art

It is conventionally realized that a workflow is registered in an image forming device such as MFP (Multi Function Peripheral) so that jobs in accordance with successive flows are automatically executed.

Japanese Laid-Open Patent Publication No. 05-316266 recites a facsimile device capable of allocating a plurality of states with respect to a one-touch button, wherein a LED luminescent color of the one-touch button is changed when the one-touch button shifts a state to a different state so that a registered object in accordance with the color is called.

A workflow including user selection, jobs separated from the network and the like inevitably requires manpower and demands a step where a human makes judgments and carries out jobs. Such a workflow cannot be completely automated. Therefore, a workflow is conventionally segmented into a plurality of workflows in which the jobs in accordance with the successive flows can be automated, and can be registered as the plurality of workflows. The conventional method, however, could not actually contribute to improvements of the user's job performance.

### SUMMARY OF THE INVENTION

The present invention was implemented to solve the foregoing problem, and a main object thereof is to provide an image forming device capable of efficiently executing a workflow, an image forming system, and a method of controlling the image forming device.

In order to achieve the foregoing object, an image forming device capable of executing a workflow including a plurality of steps according to an aspect of the present invention includes a register unit for registering a key which instructs execution of the workflow, and a control unit for executing a control processing for implementing the steps of the workflow when the key registered in the register unit is pressed.

According to another aspect of the present invention, in a method of controlling an image forming device capable of executing a workflow including a plurality of steps, the image forming device registers a key which instructs execution of the workflow, and the control method includes steps of detecting that the registered key is pressed; and executing a control processing for implementing the steps of the workflow when the registered key is pressed.

According to the present invention, when the registered key is pressed, the control processing for implementing the steps of the workflow is executed. As a result, the image forming device capable of efficiently executing the workflow, the image forming system, and the method of controlling the image forming device can be provided.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a constitution of a workflow execution system according to a first preferred embodiment of the present invention.

FIG. 2 shows a constitution of one of the PCs shown in FIG. 1.

FIG. 3 shows a constitution of an MFP 100.

FIG. 4 shows a specific example of an operation information registered by Sales A.

FIG. 5 shows a current operation information memorized in a temporary memory 107.

FIGS. 6-18 respectively show specific examples of display on an operation panel 115 in the execution of the workflow shown in FIG. 4.

FIGS. 19-29 respectively show specific examples of the display on operation panel 115 in the case where a logged-in user information is used.

FIG. 30 is a flow chart illustrating a processing executed by the MFP according to the first preferred embodiment.

FIG. 31 is a flow chart illustrating execution of an operation in the current operation information in step S117 shown in FIG. 30.

FIG. 32 is a flow chart illustrating a processing executed between step S105 and step S107 shown in FIG. 30.

FIG. 33 shows a constitution of a workflow execution system according to a second preferred embodiment of the present invention.

FIG. 34 shows a specific example of a user authentication table.

FIG. 35 shows a specific example of the operation information.

FIG. 36 shows a specific example of the current operation information.

FIG. 37 shows a specific example of a key display flag information.

FIGS. 38-41 respectively show specific examples of the display on operation panel 115.

FIG. 42 is a flow chart illustrating a top screen display processing executed by the MFP.

FIG. 43 is a flow chart illustrating a processing executed by an MFP control server 300.

FIG. 44 is a flow chart illustrating a processing executed by the MFP.

FIG. 45 is a flow chart illustrating a processing executed by the MFP when an order placement key is pressed on the top screen of the MFP.

### DESCRIPTION OF THE PREFERRED EMBODIMENTS

### First Embodiment

Hereinafter, a workflow execution system according to a first preferred embodiment of the present invention is described. In the system according to the present preferred embodiment, a workflow demanding manpower is processed. The workflow includes a plurality of steps. The execution of each step is triggered when one key is pressed. More specifically, when a person in charge presses one key, the MFP is instructed to execute the workflow, and the workflow can be thereby smoothly carried out.

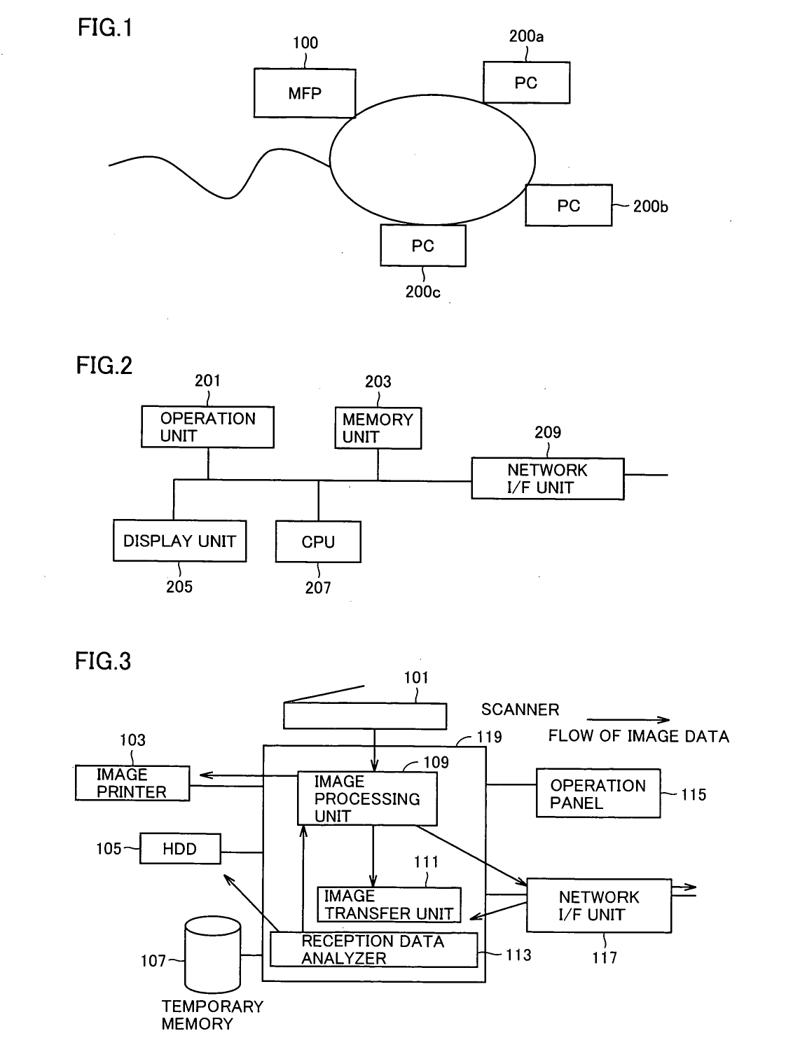

FIG. 1 shows a constitution of the workflow execution system according to the first preferred embodiment.

As shown in the drawing, an MFP 100 and a plurality of PCs (personal computers) 200a-200c are connected by a network in the workflow execution system.

FIG. 2 shows a constitution of one of the PCs shown in FIG. 1.

Referring to the drawing, the PC includes a memory unit (HDD (Hard Disc Drive) 203, an operation unit 201, a display unit 205, a CPU 207 and a network I/F unit 209, and these components are connected to the network.

Memory unit 203 memorizes therein different application softwares installed by a user. The application softwares include a driver associated with the MFP. When the user issues a printing instruction in the PC, data is transmitted to MFP 100 via the driver, and MFP 100 prints the data.

A browser (browsing software) is also included in memory unit 203. When the user designates an IP address of the device to thereby issue an instruction for obtaining data, the PC can obtain the data by way of the browser. Memory unit 203 also includes a mailing software, and data present in the device or data scanned in the device can be obtained from the device.

FIG. 3 shows a constitution of MFP 100.

Referring to the drawing, MFP 100 includes a scanner (original image reader) 101, an image controller 119 including an image processing unit 109 and an image transferring unit 111, a reception data analyzer 113, a temporary memory 107, an operation panel 115, a network I/F 117, an image printer 103 and a HDD 105, and these components are connected to the network.

When an image is transmitted, scanner 101 scans an original image based on reading conditions set on operation panel 115, and transfers the scanned image to image controller 119. Image controller 119 image-converts the image received from scanner 101 in image processing unit 109 based on image processing settings of operation panel 115 and transfers the converted image to image transferring unit 111.

Image transferring unit 111 determines a destination of the transmission of the image based on transmission settings of operation panel 115 and transfers the image data by way of network I/F 117.

When the image is received, MFP 100 receives the data by way of network I/F 117 and transfers the received data to reception data analyzer 113 so that the data is analyzed therein. In the case where the data is faxed data and printed data, the data is image-converted based on the image processing settings in image processing unit 109 and transferred to image printer 103 so that the data is printed in image printer 103. In the case where the data is stored data, the data is stored in HDD 105.

As described, it is necessary to set the reading conditions and transmission conditions with respect to MFP 100 when the image is transmitted, however, address information, reading conditions, transmission conditions, workflow and the like can be registered by means of operation panel 115 or the software on the PC as program keys in order to reduce the user's labor. The user can execute any operation based on the registered settings by merely selecting the program keys.

The program key referred to in this specification is a key with which an operation is associated and is generally called a one-touch key, workflow key, or the like depending on a type of the operation. The key is displayed in a shape of a button on operation panel 115.

There is hypothetically a workflow including the following 1)-7) steps, which is a workflow of an order placement system.

1) A sales person A (Sales A) sends a purchase application document format (purchase application.pdf) stored in BOX 1 in HDD 105 of MFP to a PC of Sales A (mail address: aaa@abcde.jp) by accessing operation panel 115 of MFP 100.

2) Sales A collects necessary information using the PC, telephone, mail, oral communication or the like, or makes any necessary choice depending on situations, and prints a purchase application document which information on a merchandise to be purchased is filled in using MFP in accordance with the purchase application document format.

3) Sales A obtains an approval stamp on the printed purchase application document from a section manager B. Sales A scans the approved purchase application document in MFP to thereby convert it into electronic data. Sales A sends the electronic data to a PC of an administrative person C (ccc@abcde.jp).

4) Administrative Person C confirms the purchase application document, and then, operates operation panel 115 of MFP to thereby send an order document format (order.pdf) stored in BOX 2 in HDD 105 of MFP to the PC of Administrative Person C (ccc@abcde.jp).

5) Administrative Person C draws up an order document which includes the information of the purchase application document in accordance with the order document format and prints using on MFP.

6) Administrative Person C stamps the printed order document, scans the order document in MFP, and sends the scanned document to a distributor D (FAX No.: 03-1234-5678) using G3FAX.

7) MFP inputs a contact information and transmits a completion notice when the transmission via G3FAX is completed.

Sales A registers an operation information in association with a workflow key in accordance with the foregoing workflow using an application software for setting operation panel 115 of MFP and MFP. The operation information is stored in temporarily memory 107 of MFP.

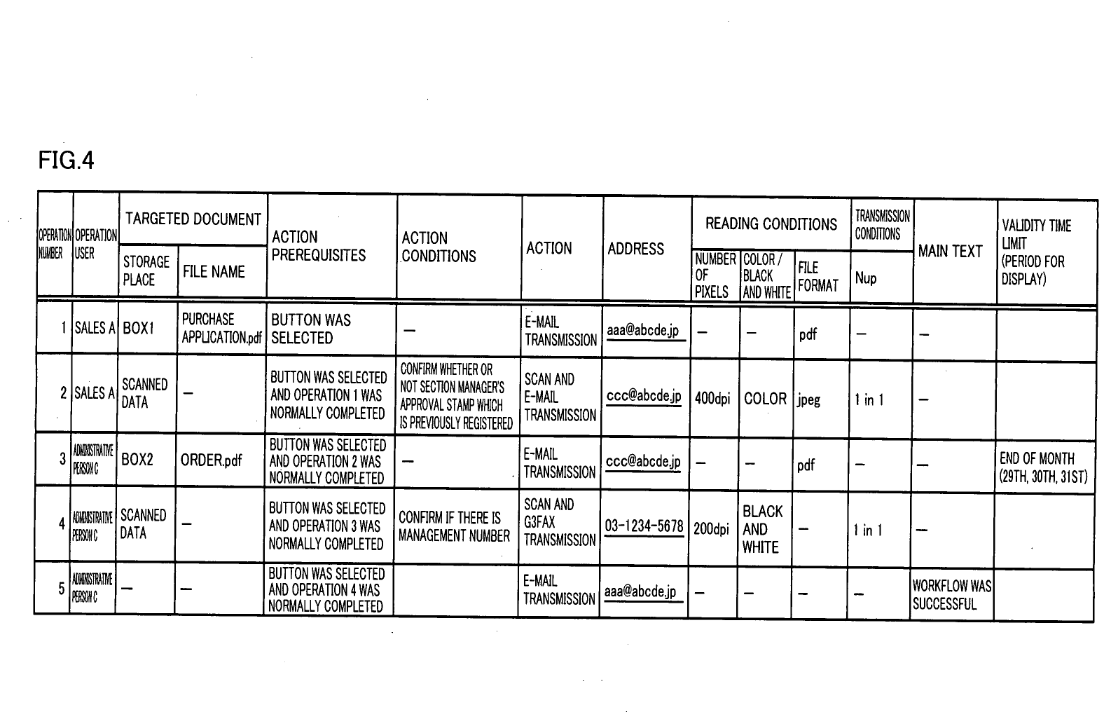

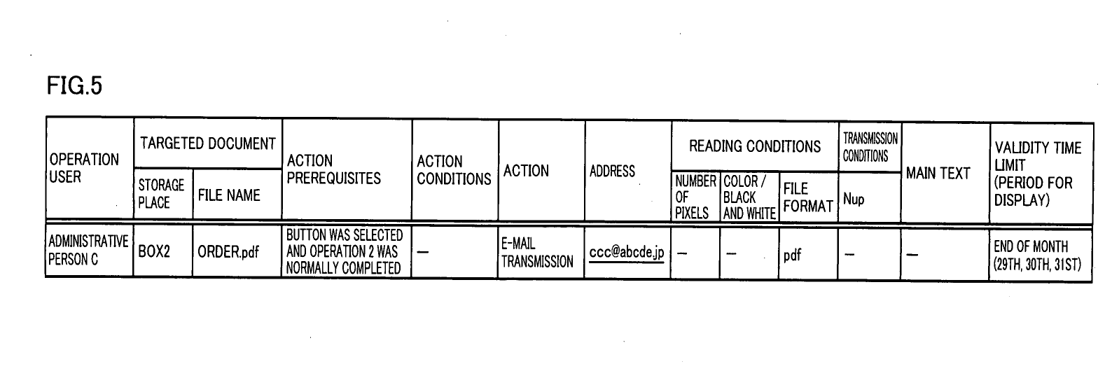

FIG. 4 shows a specific example of the operation information registered by Sales A.

As shown in the drawing, the operations including the transmission in the workflow are registered in the operation information as five steps respectively provided with operation numbers 1-5.

In the respective operation numbers, operation users, targeted documents, action prerequisites, action conditions, actions, addresses, reading conditions, transmission conditions, main texts, and validity time limit (time limit for display) are registered.

The operation user is a user who is scheduled to execute the operation, and the targeted document is a document to be processed. The targeted document recites a storage place and a file name relevant to the targeted document.

The action prerequisites are conditions for starting the operations of the respective operation numbers. For example, the operation of operation number 1 starts when the key (button) corresponding to the execution of the workflow is pressed (selected). The operation of operation number 2 starts when the operation of operation number 1 is normally terminated, and the key corresponding to the execution of the workflow is pressed.

The action conditions are conditions for the operation execution determined by the processing unit of MFP. The operations of the respective operation numbers are executed when the respective action conditions are satisfied, while an error is shown when they are not satisfied. For example, the operation of operation number 2 is not executed if the previously registered section manager's stamp is not seen on the scanned document (if the image data of the section manager's stamp is not included).

The action denotes contents of the relevant operation, and the address denotes a destination of the transmission of the mail and the FAX.

The reading conditions denote the image reading conditions when the scan is implemented. The reading conditions recite number of pixels, color/black and white, and output file format. In the transmission conditions, Nin1 can be set. Referring to the main text, the main text of the document to be transmitted is previously registered at the time of the transmission if necessary.

The validity time limit defines a time limit when the operation is valid. The relevant key for executing the operation is displayed if a current date and time are within the validity time limit, while the key is not displayed if the current date and time are beyond the validity time limit (for example, the key may be displayed in a gray-out fashion so that it cannot be selected). For example, the key for executing the operation of operation number 3 is displayed only on the dates of 29th, 30th, and 31st.

FIG. 5 shows a current operation information memorized in temporary memory 107.

In the drawing, a state where the operations up to the operation number 2 shown in FIG. 4 are completed is shown, and the operation of the operation number 3 is recorded as the operation information.

When the user selects the workflow key on operation panel 115, MFP accesses temporary memory 107 and obtains the operation information shown in FIG. 4. MFP executes the processing based on the obtained operation information and displays the information on the operation panel 115.

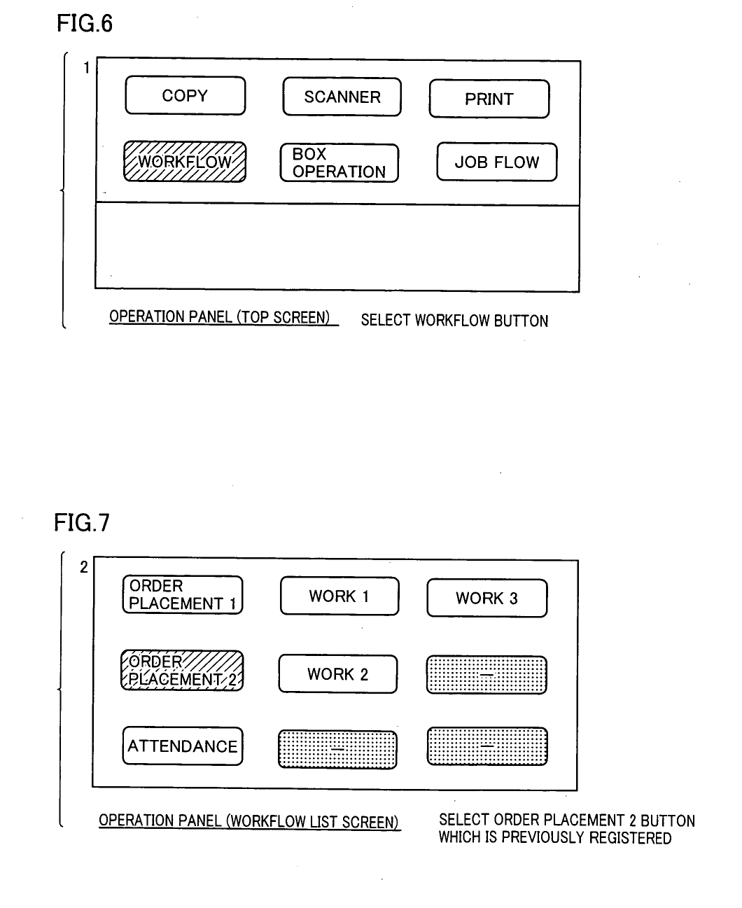

FIGS. 6-18 respectively show specific examples of the display on operation panel 115 in the workflow execution shown in FIG. 4.

Referring to FIGS. 6-18, the display on the operation panel 115 in the foregoing workflow and the user's operation are described. The keys shown in white boxes in the drawings are the selectable keys, the keys shown in oblique line hatching are the keys selected by the user, and the keys shown in dotted hatching are the non-selectable keys displayed in the gray-out.

A screen shown in FIG. 6 is displayed on operation panel 115 as a top screen of MFP.

Sales A goes to MFP and selects the “workflow” key on operation panel 115. As shown in FIG. 7, the keys for executing the registered workflows are displayed as a list on MFP as a result of the selection.

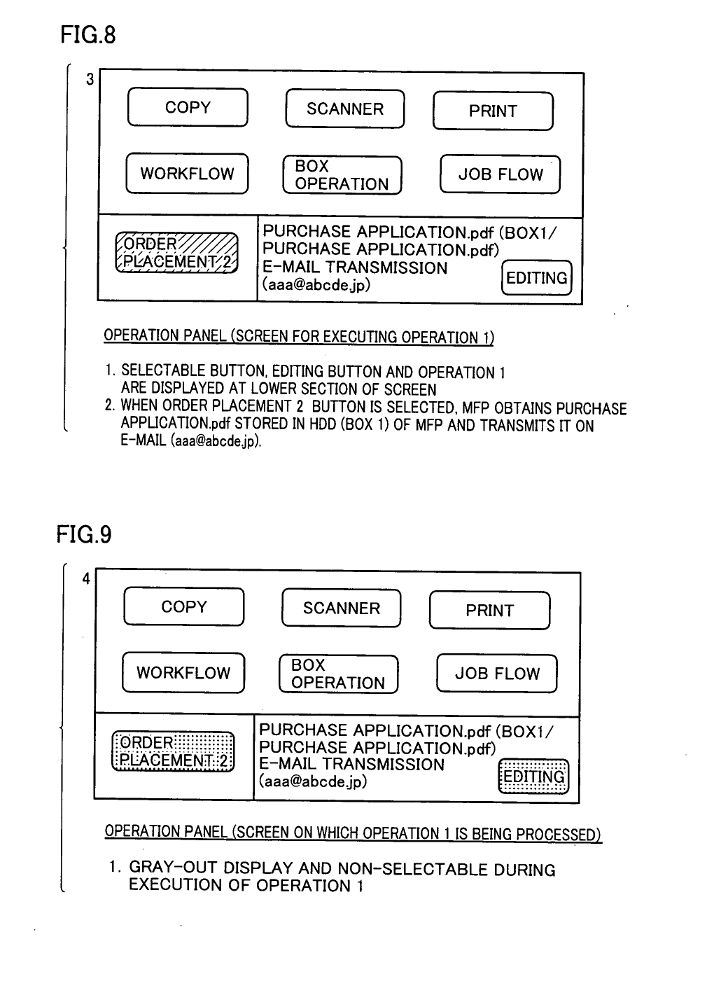

More specifically, FIG. 7 shows that six workflows, which are “order placement 1”, “order placement 2”, “attendance”, “work 1”, “work 2” and “work 3”, are registered, and the user presses the key of the workflow he/she desirably executes. Assuming that the key of “order placement 2” is pressed now, the workflow of “order placement 2” starts, and the top screen is displayed again as shown in FIG. 8. In this description, “order placement 2” is the workflow shown in the operation information of FIG. 4.

On the top screen shown in FIG. 8, information showing work duties and the selectable keys are displayed at a lower section of the screen until the workflow of “order placement 2” is terminated. When the users select the keys, the respective operations are executed based on the obtained setting information.

In the drawing, the operation of operation number 1 shown in FIG. 4 is being executed. More specifically, the transmission of the file of purchase application.pdf in BOX 1 to aaa@abcde.jp is displayed at the lower section of the screen as the operation to be executed, and the key of “order placement 2” is displayed. Further, an editing key for editing the operation is displayed. When the user presses the editing key, contents of the operation (targeted document, destination of the transmission, and the like) can be changed.

When the user (Sales A) presses the key of “order placement 2”, MFP obtains the file of purchase application.pdf stored in BOX 1 and transmits the obtained file to aaa@abcde.jp on the electronic mail. When the key of “order placement 2” is pressed in FIG. 8, the operation of operation number 1 is executed. As shown in FIG. 9, the keys of “order placement” and “editing” are displayed in the gray-out during the execution, therefore, cannot be selected.

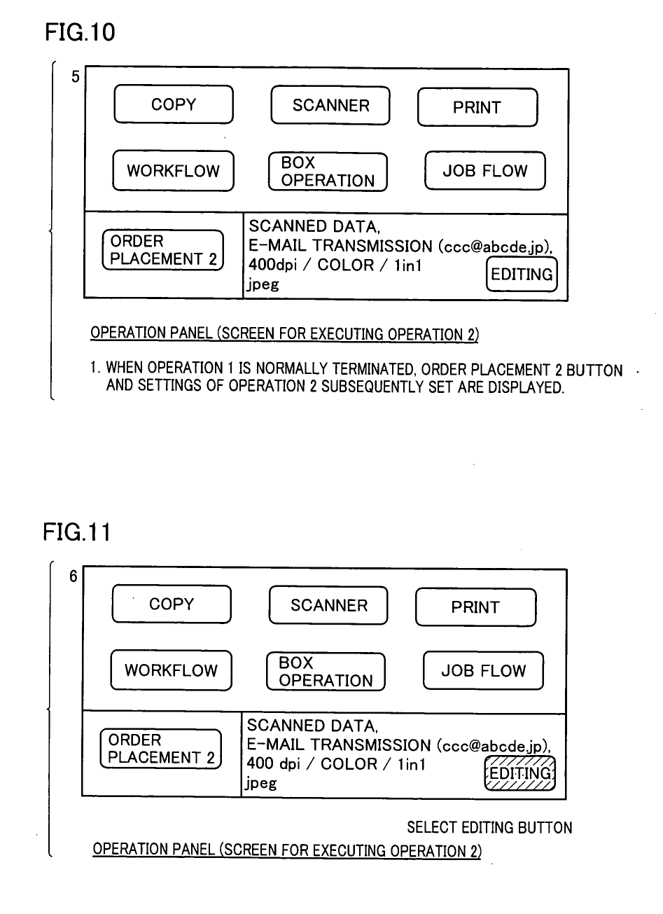

When the operation of operation number 1 is terminated, the operation of operation number 2 is displayed on the top screen as shown in FIG. 10. In the drawing, the operation of operation number 2 shown in FIG. 4 is being executed. More specifically, it is shown at the lower section of the screen that the data is obtained through scan and the resulting file is transmitted to ccc@abcde.jp as the operation to be executed, and the key of “order placement 2” is displayed. Further, the editing key for editing the operation is displayed. When the user (Sales A) presses the editing key, contents of the operation (number of pixels, color/black and white, file format, destination of the transmitted file and the like) can be changed.

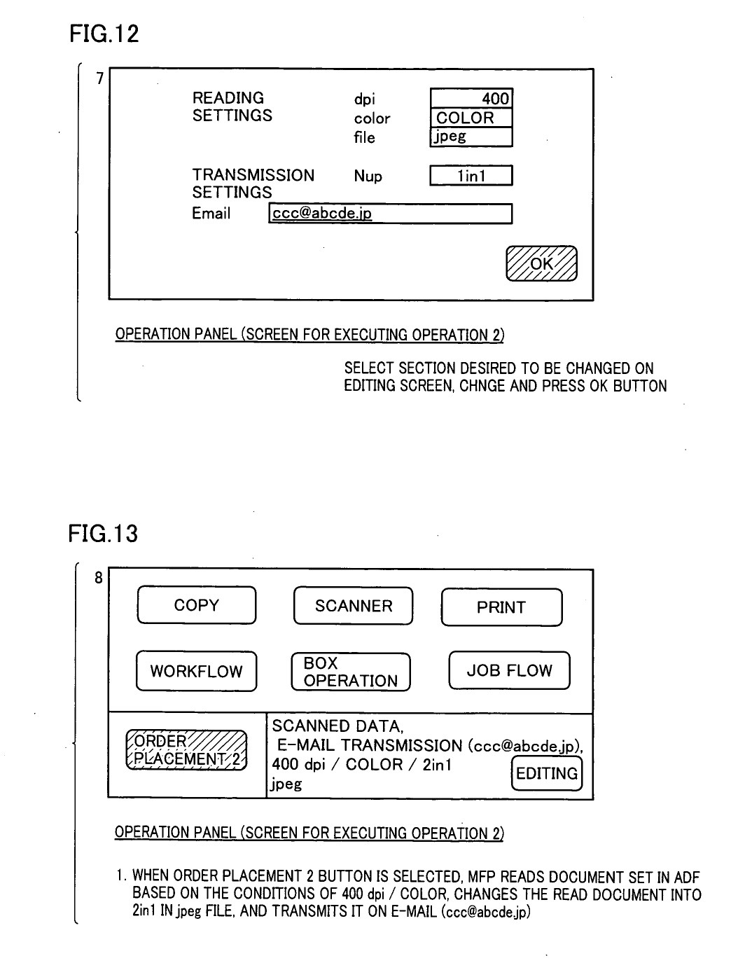

More specifically, when the “editing” key is pressed as shown in FIG. 11, an editing screen for changing respective settings is displayed as shown in FIG. 12, and the change made by the user is accepted. When the user presses an “OK” key in FIG. 12, the top screen is displayed again as shown in FIG. 13. In this example, 1in1 is changed to 2in1.

When Sales A presses the key of “order placement 2” on the screen shown in FIG. 13, MFP reads a document set in ADF (Auto Document Feeder) based on set conditions (400 dpi, color), converts the read document into 2in1 in a jpeg file, and transmits the resulting data to ccc@abcde.jp.

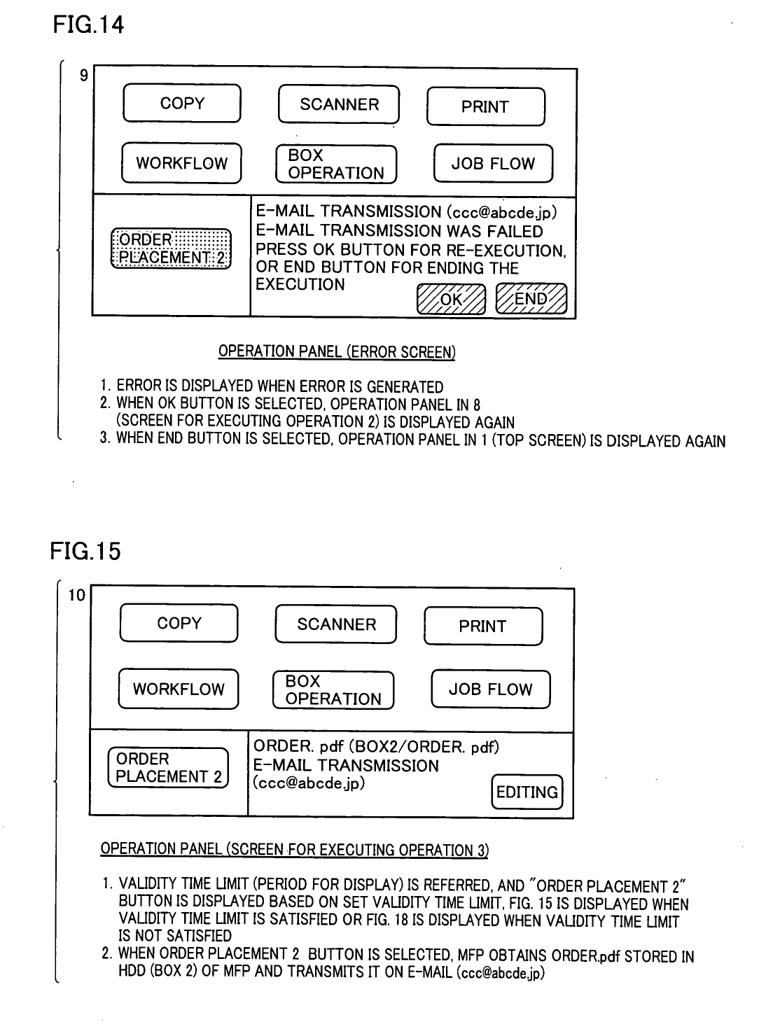

When an error is generated during the processing, an error screen shown in FIG. 14 is displayed. The screen shown in FIG. 13 is displayed again when the “OK” key is pressed, and the screen shown in FIG. 6 is displayed again when an “end” key is pressed. Examples of the error include error in the scan, error in the transmission, failure to satisfy the action conditions, and the like.

As shown in FIG. 4, the validity time limit is provided for operation number 3 which is the next operation. Assuming that the current date and time is within the validity time limit, the operation of operation number 3 is displayed on the top screen when the operation of operation number 2 is terminated as shown in FIG. 15.

When the user (Administrative Person C) presses the key of “order placement 2”, MFP obtains the file of order.pdf in BOX 2 and transmits the obtained file to ccc@abcde.jp.

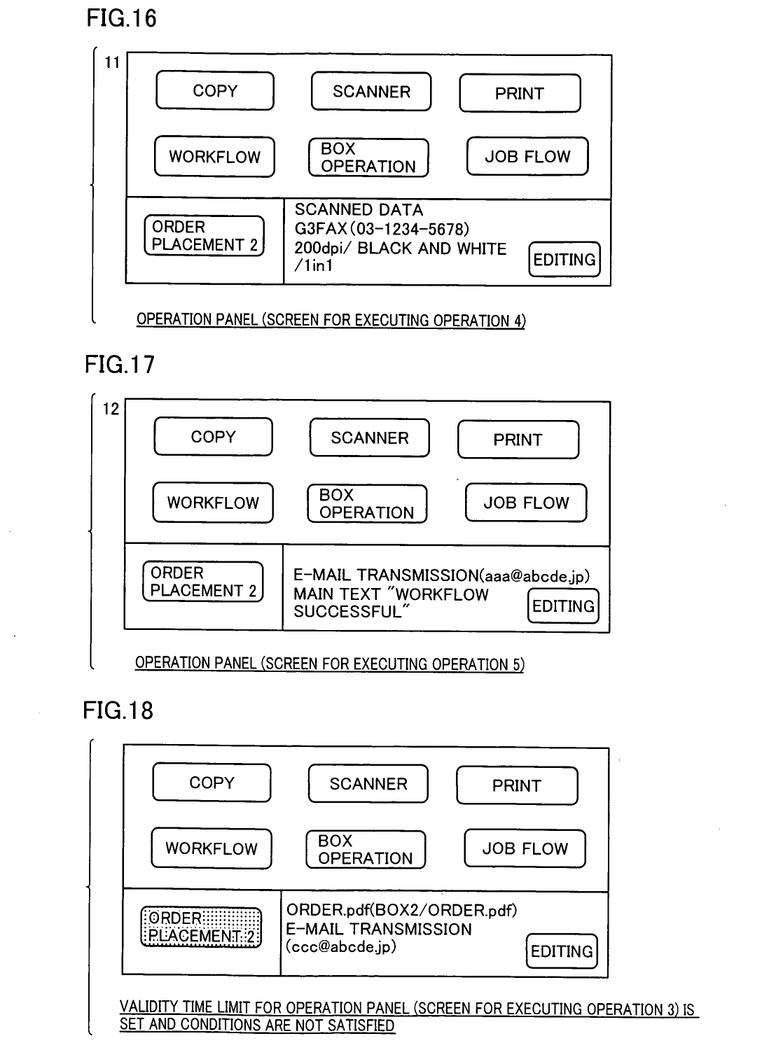

The display of operation panel 115 and the key input are repeated until the registered operations in FIG. 16 (operation number 4) and FIG. 17 (operation number 15) are completed. Further, the user selects the editing key and makes any necessary change on the editing screen when he/she desirably changes the settings of the respective operations.

In the case of the failure to satisfy the validity time limit in the operation of operation number 3, the key of “order placement 2” is displayed in the gray-out and cannot be pressed as shown in FIG. 18.

As an alternative constitution, the workflow key may be pressed only in the case where the user is requested to log-in in MFP, and the logged-in user and the operation user registered in the registered information correspond to each other.

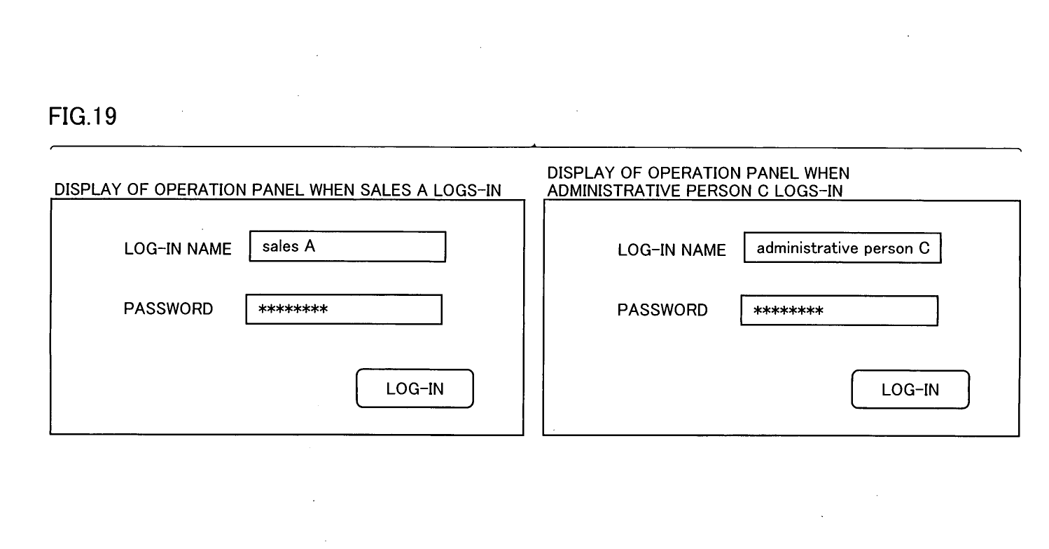

FIGS. 19-29 shows specific examples of the display on operation panel 115 in the case where a logged-in user information is used.

In the drawings, a left box shows the display when Sales A logged in, while a right box shows the display when Administrative Person C logged in. In the log-in, a log-in name and a password are inputted on a screen shown in FIG. 19.

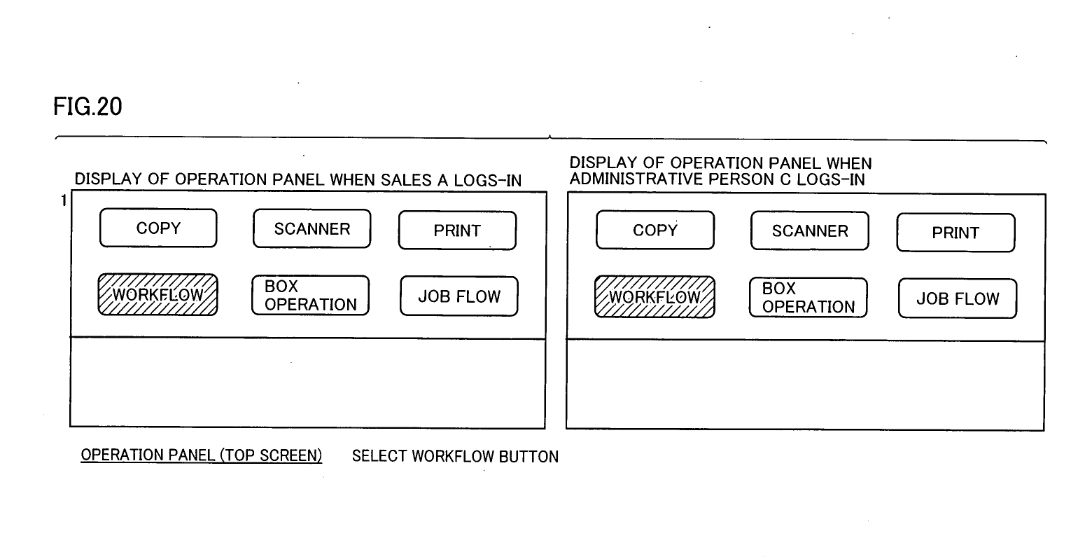

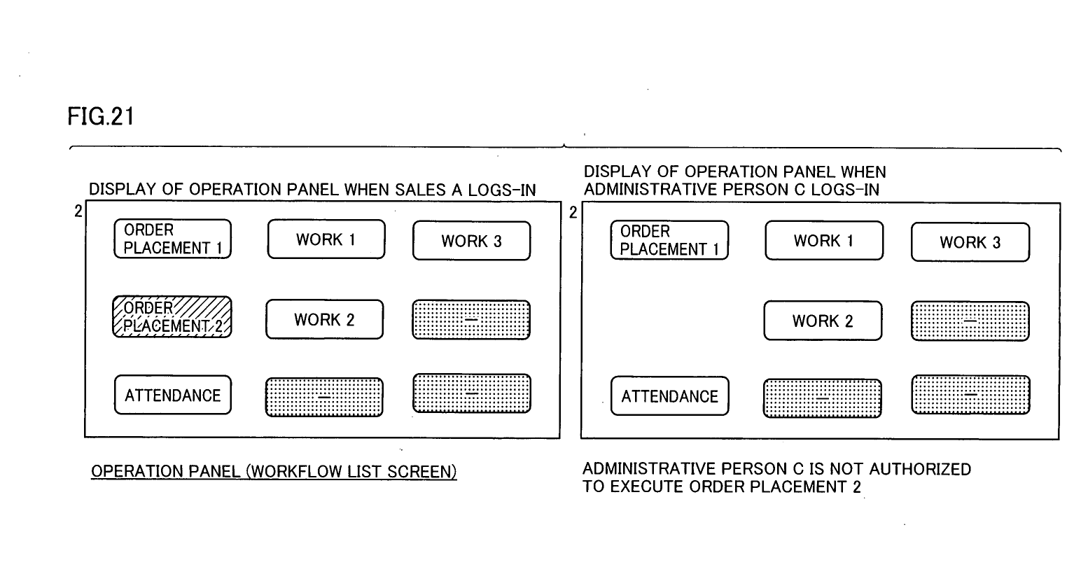

The both users can execute the workflow in the state where the top screen is shown as shown in FIG. 20. However, it is only Sales A who can start the workflow of “order placement 2” as shown in FIG. 4. Therefore, the key of “order placement 2” is displayed on a workflow list screen shown in FIG. 21 only when Sales A logs-in.

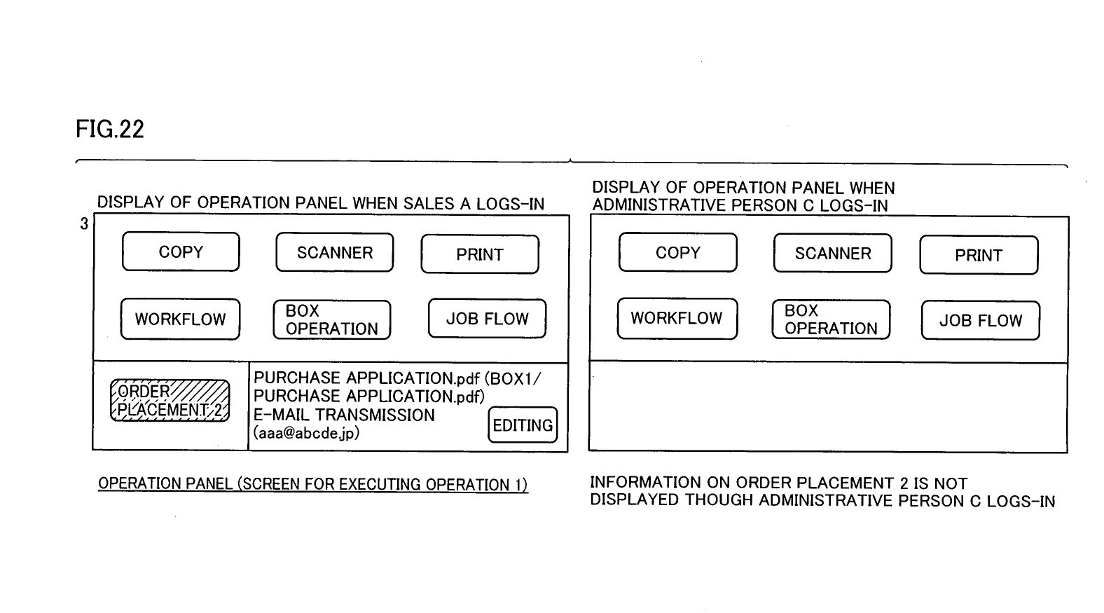

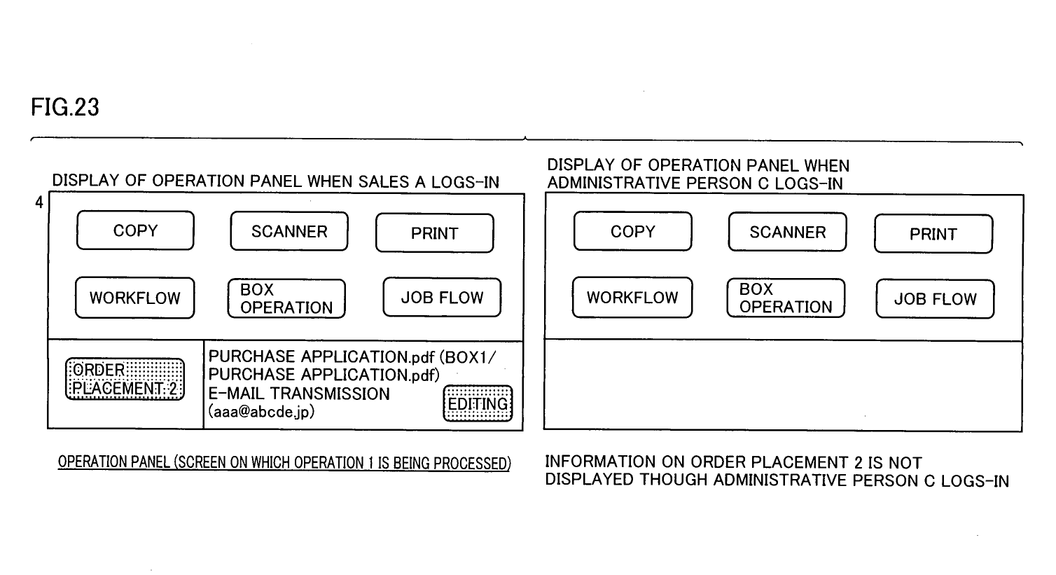

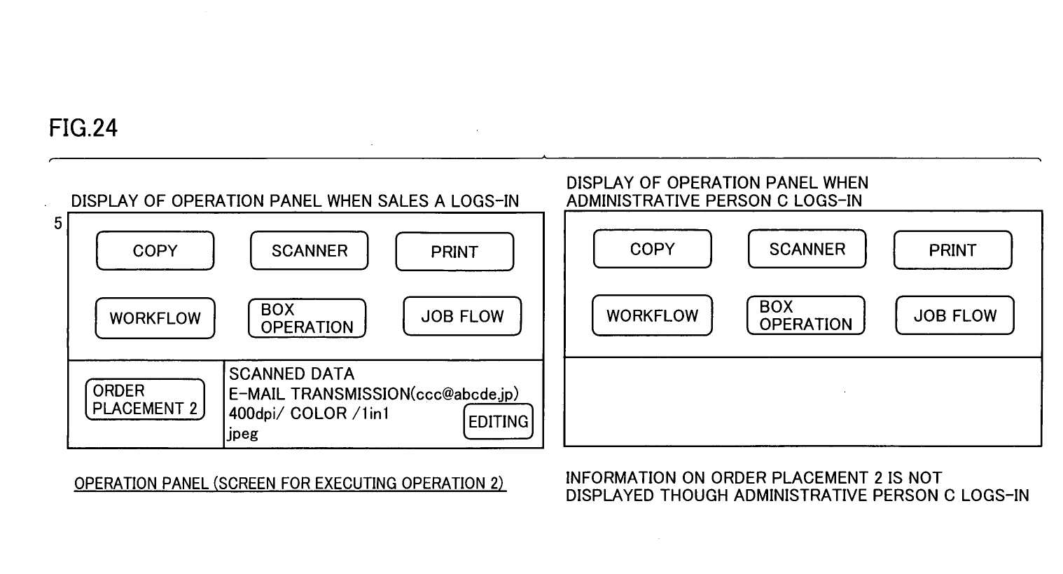

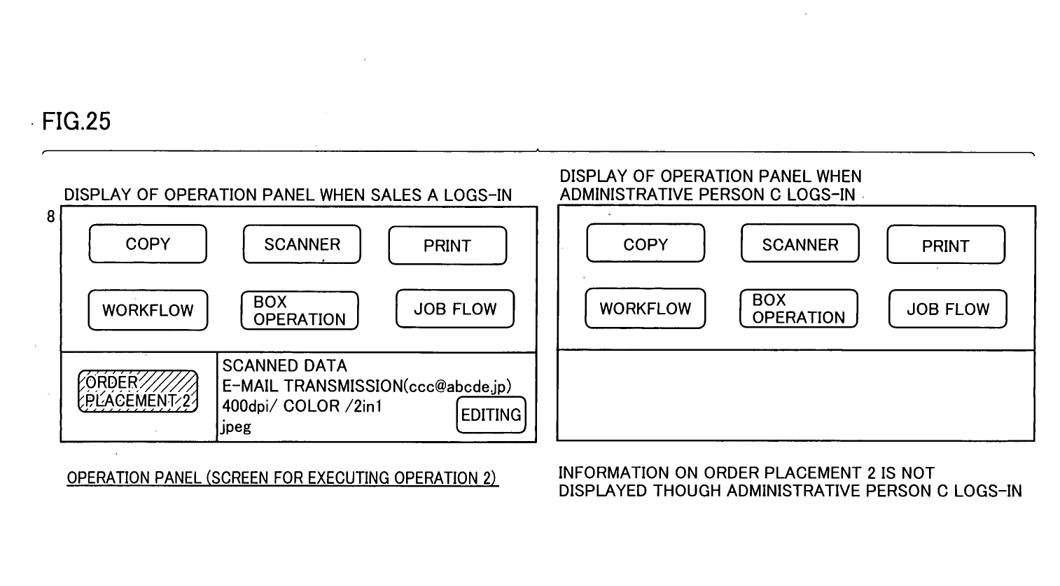

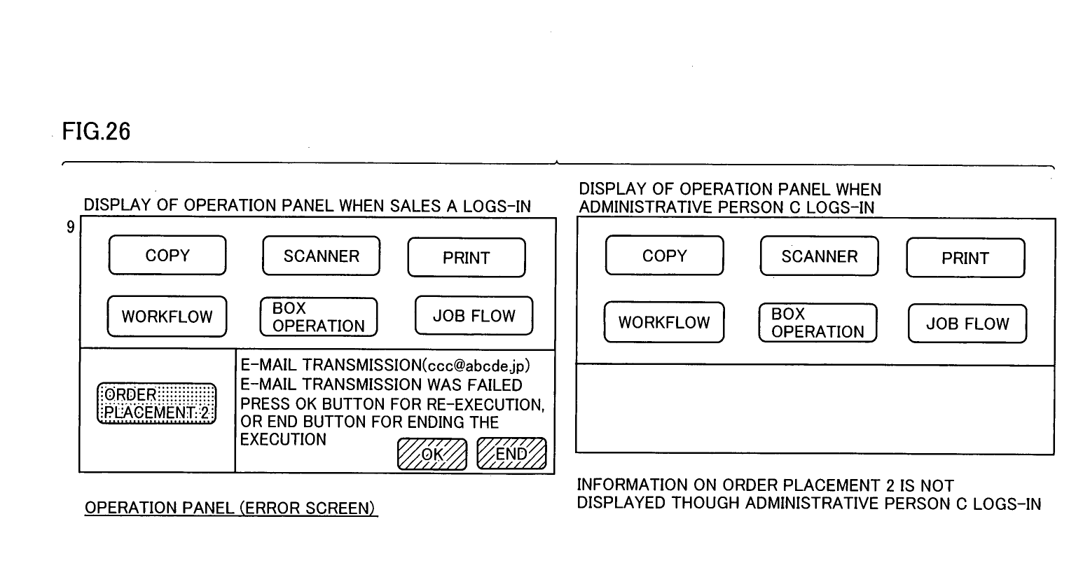

In FIG. 22 (start of the operation of operation number 1), FIG. 23 (the operation of operation number 1 is being executed), FIG. 24 (start of the operation of operation number 2), FIG. 25 (the operation of operation number 2 is being executed) and FIG. 26 (the operation of operation number 2 is being error-displayed) wherein the operation user is Sales A (see FIG. 4), the key of “order placement 2” and the information are displayed only when Sales A logs-in.

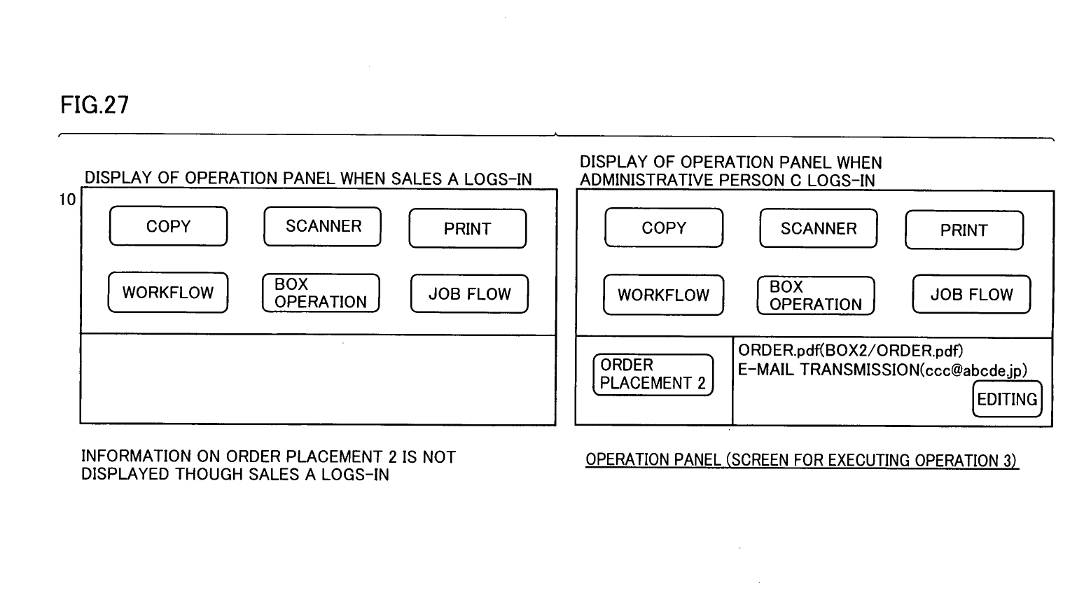

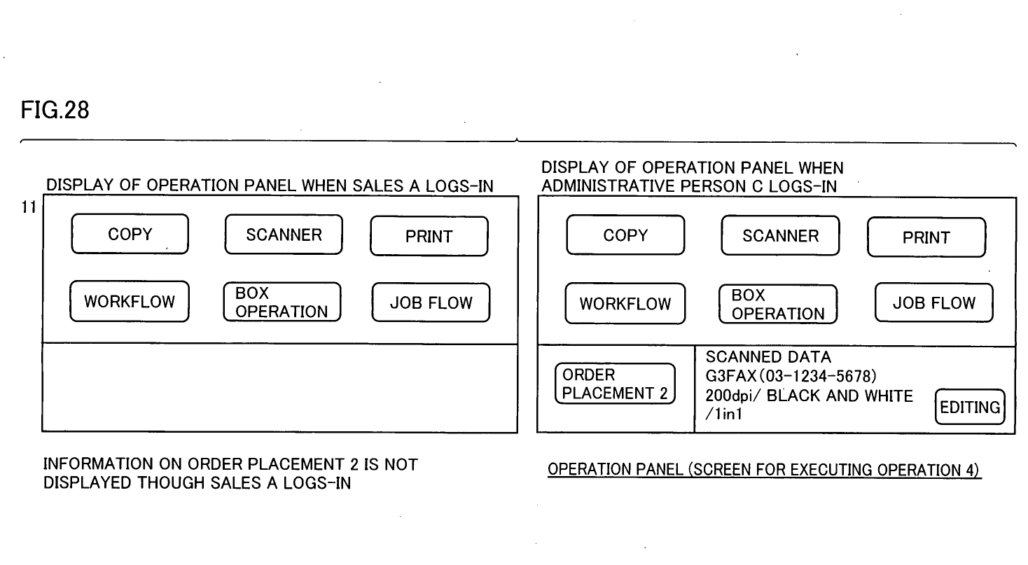

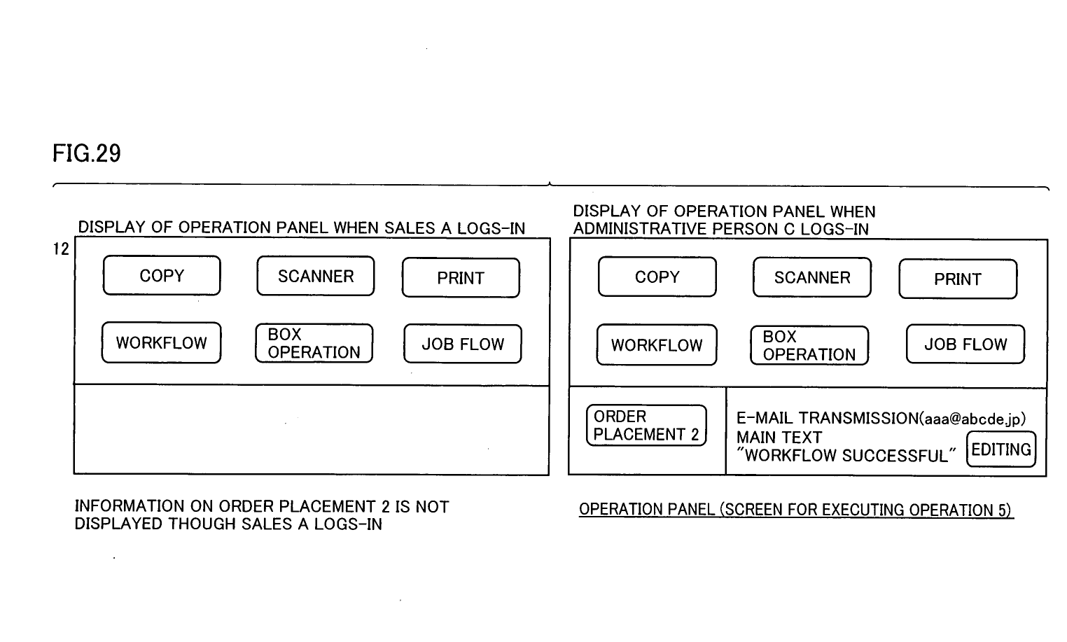

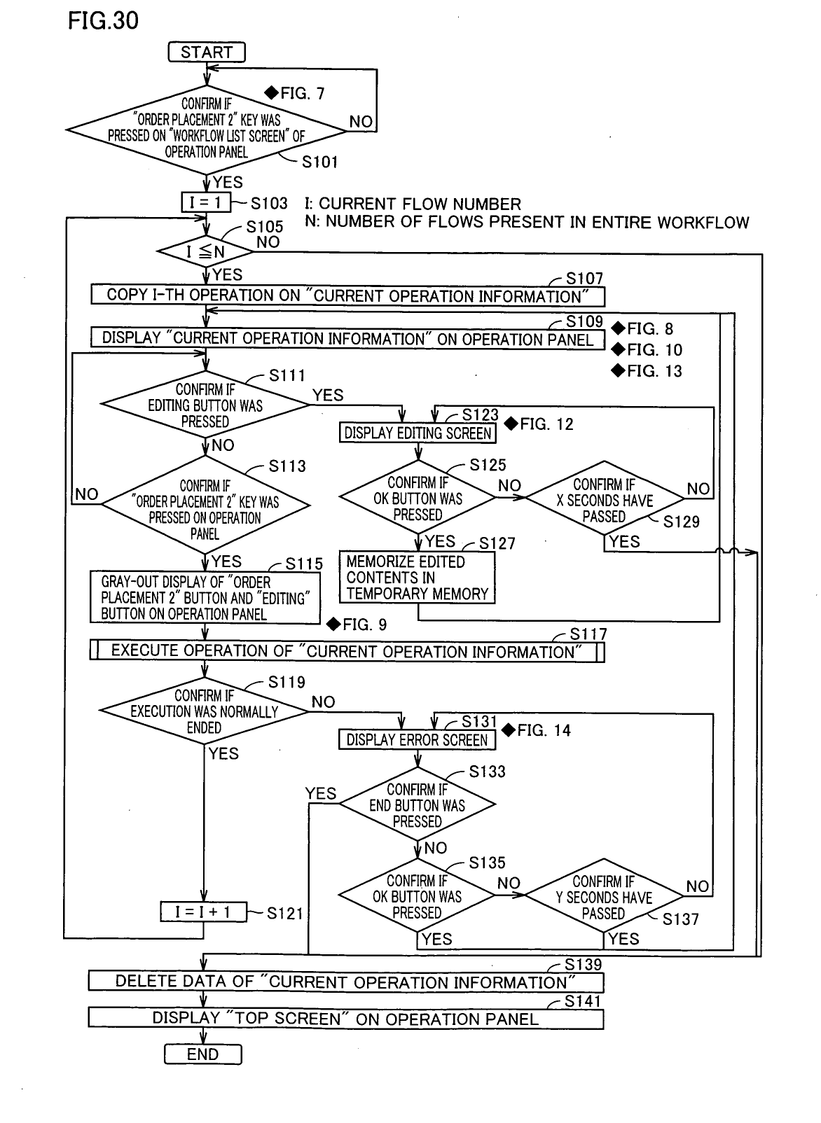

In FIG. 27 (start of the operation of operation number 3), FIG. 28 (the operation of operation number 4 is being executed) and FIG. 29 (the operation of operation number 5 is being executed) wherein the operation user is Administrative Person C (see FIG. 4), the key of “order placement 2” and the information are displayed only when Administrative Person C logs-in.

The foregoing operations are executed through the following processing by MFP.

When the key of “order placement 2” is pressed on the “workflow list screen” of operation panel 115, MFP accesses the operation information (FIG. 4) of temporary memory 107 and stores information of a processing to be executed subsequent to the current operation information (FIG. 5).

MFP accesses the current operation information and displays the operation information on operation panel 115. At the time, the editing screen is displayed when the editing key is pressed by the user, and the current information is overwritten with the edited information.

When the OK key is pressed on the editing screen, the current operation information is displayed.

Every time when the key of “order placement 2” is pressed by the user, the relevant operation is executed in accordance with the current operation information. As an example of the action conditions, the operation is executed only when the section manager's approval stamp which is previously registered is confirmed on the scanned document. In the presence of such conditions, the operation is executed only when the conditions are satisfied.

For example, the original document is pre-scanned with ADF in the case of the operation of operation number 2 shown in FIG. 4 so that the image is checked. When it is known that the conditions are satisfied, the original document is scanned again in accordance with the reading conditions, and the scanned document is transmitted to the set destination. If the transmission is successful, the operation information (FIG. 4) is accessed, and the information to be executed subsequent to the current operation information (FIG. 5) is stored.

The foregoing processing is repeated until the operations registered in the operation information (FIG. 4) are terminated. The error screen is displayed in the transmission failure or the like. When the OK key is selected by the user on the error screen, the failed operation is displayed on the top screen so as to encourage redo of the operation. When the end key is selected, the data of the current information (FIG. 5) is deleted, and the top screen is displayed.

FIG. 30 is a flow chart illustrating the processing executed by MFP according to the present preferred embodiment.

Referring to the drawing, it is determined in step S101 if the key of “order placement 2” was pressed on the workflow list screen (FIG. 7) of operation panel 115. When a result of the determination shows YES, “1” is assigned to a variable I showing the number of the current flow in step S103.

In step S105, it is determined if variable I is at most N showing the number of the flows present in the entire workflow, and the processing proceeds to step 107 when the determination result shows YES, while proceeding to step S139 when the determination result shows NO. In FIG. 4, N is five.

In step S107, an operation of I-th operation number is copied on the current operation information (FIG. 5). Then, the current operation information is displayed on the top screen in step S109.

It is determined if the “editing” key is pressed in step S111. When the determination result shows NO, it is determined in step S113 if the key of “order placement 2” was pressed.

When the determination result shows YES in step S113, the key of “order placement 2” and the “editing” key on operation panel 115 are displayed shown in the gray-out in step S115, and the operation of the current operation information (FIG. 5) is executed in step S117. It is determined if the execution was normally terminated in step S119. When the determination result shows YES, the value of I is 1-incremented by in step S121, and the processing returns to step S105.

When the value of I is not at most N in step S105, the data of the current operation information is deleted in step S139, and the top screen is displayed on operation panel 115 in step S141. Then, the processing is terminated.

When the determination result shows YES in step S111, the editing screen is displayed in step S123 so that the editing is accepted. It is determined if the “OK” key was pressed in step S125. When the determination result shows YES, the edited contents are memorized in temporary memory 107, and the processing returns to step S109.

When the determination result shows NO in step S125, it is determined if a predetermined amount of time has passed in step S129. The processing proceeds to step S139 when the determination result shows YES, while returning to step S123 when NO.

When the determination result shows NO in step S113, the processing returns to step S111.

When the determination result shows NO in step S119, the error screen is displayed in step S131, and it is determined if the end key was pressed in step S133. The processing proceeds to step S139 when the determination result shows YES. When the determination result shows NO, it is determined if the “OK” key was pressed in step S135, and the processing return to step S109 when the determination result shows YES. When the determination result shows NO, it is determined if a predetermined amount of time has passed in step S137. The processing returns to step S131 when the determination result shows NO, while returning to step S109 when YES.

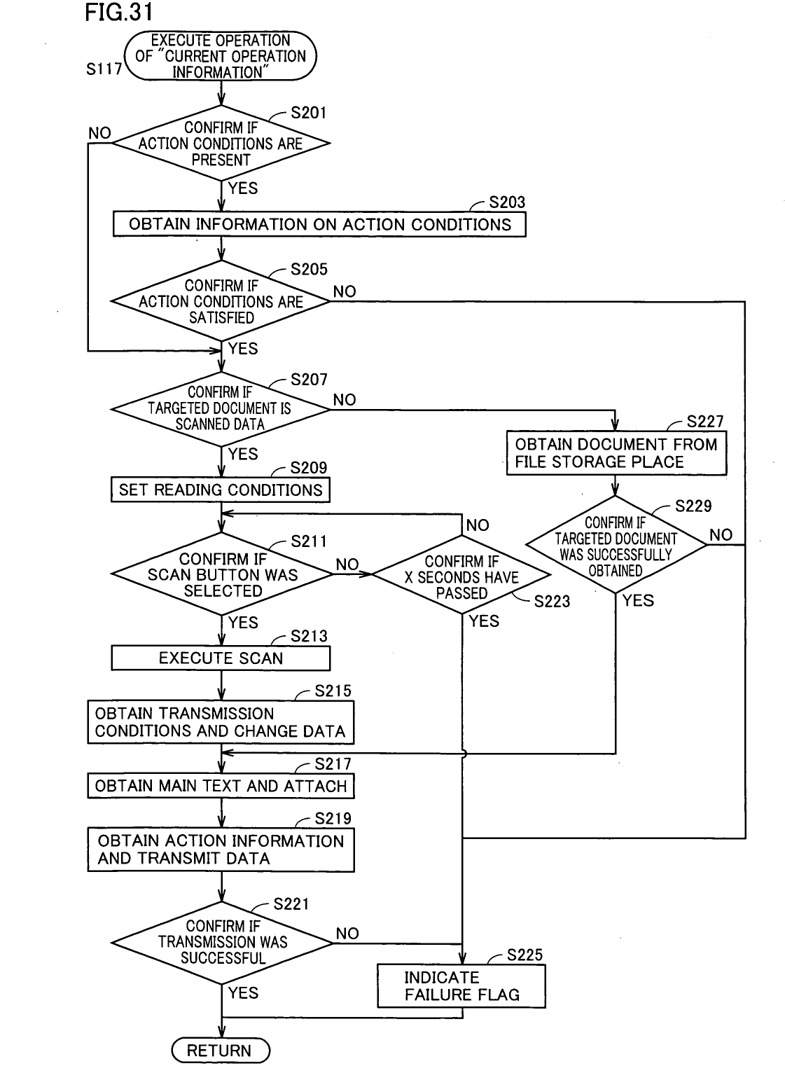

FIG. 31 is a flow chart illustrating the execution of the operation in the current operation information shown in step S117 in FIG. 30.

It is determined in step S201 if the action conditions are present in the current operation information (FIG. 5). When the determination result shows YES, the information of the action conditions is obtained in steps S203. It is determined in step S205 if the action conditions are satisfied. When the determination result shows YES, it is determined in step S207 if the targeted document is the scanned data. When the determination result shows YES, the reading conditions are set in step S209.

It is determined in step S211 if the scan button on operation panel 115 was selected. When the determination result shows YES, the scan is implemented in step S213. In step S215, the transmission conditions are obtained and the data is converted. Thereafter, the main text shown in FIG. 4, if present, is obtained in step S217, and the data is transmitted to the destination address in step S219. It is determined if the transmission was successful in step S221, and the processing returns to the main routine when the determination result shows YES.

When the determination result shows NO in step S201, the processing proceeds to step S207.

When the determination result shows NO in step S205, a failure flag is indicated in step S225, and the processing returns to the main routine.

When the determination result shows NO in step S207, the document is obtained from the file storage place in step S227. It is determined in step S229 if the targeted document was successfully obtained. The processing proceeds to step S217 when the determination result shows YES, while proceeding to step S225 when NO.

When the determination result shows NO in step S211, it is determined if a predetermined amount of time has passed in step S223. The processing returns to step S211 when the determination result shows NO, while proceeding to step S225 when YES.

When the determination result shows NO in step S221, the processing proceeds to step S225.

As shown in FIGS. 19-29, the following processing is executed when the display is changed depending on the log-in conditions.

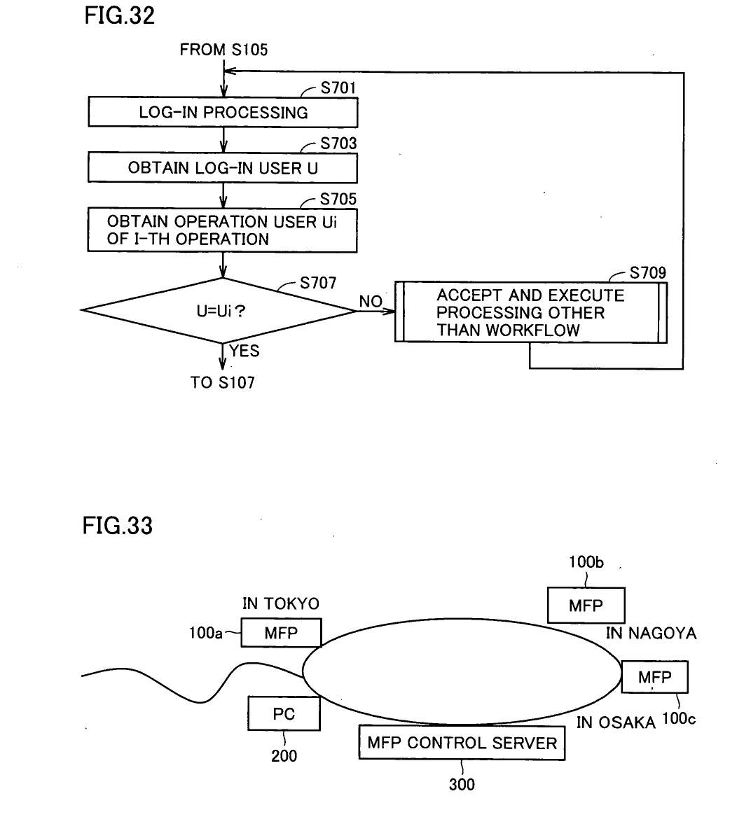

FIG. 32 is a flow chart illustrating the processing executed between steps S105 and S107 in FIG. 30.

Referring to the drawing, the log-in processing is executed in step S701. A log-in user U is obtained in step S703, and an operation user (FIG. 4) Ui of the I-th operation is obtained in step S705.

It is determined if U=Ui in step S707, and the processing proceeds to step S107 when the determination result shows YES. When the determination result shows NO, the processing other than the workflow being currently executed is accepted in step S709, and the accepted processing is executed. Thereafter, the processing returns to step S701.

### Second Embodiment

Hereinafter, a workflow execution system according to a second preferred embodiment of the present invention is described.

FIG. 33 shows a constitution of the workflow execution system according to the second preferred embodiment.

As shown in the drawing, the workflow system includes a plurality of MFPs 100a-100c, a PC 200 (there may be a plurality of PCs 200) and a MFP control server 300 for controlling the MFPs at respective locations, which are connected to one another via a network. The MFPs 100a-100c are provided at the different locations, and MFP 100a in Tokyo, MFP 100b in Osaka and MFP 100c in Nagoya respectively access MFP control server 300 at constant time intervals using, for example, HTTP. The respective MFPs are managed by means of user authentication.

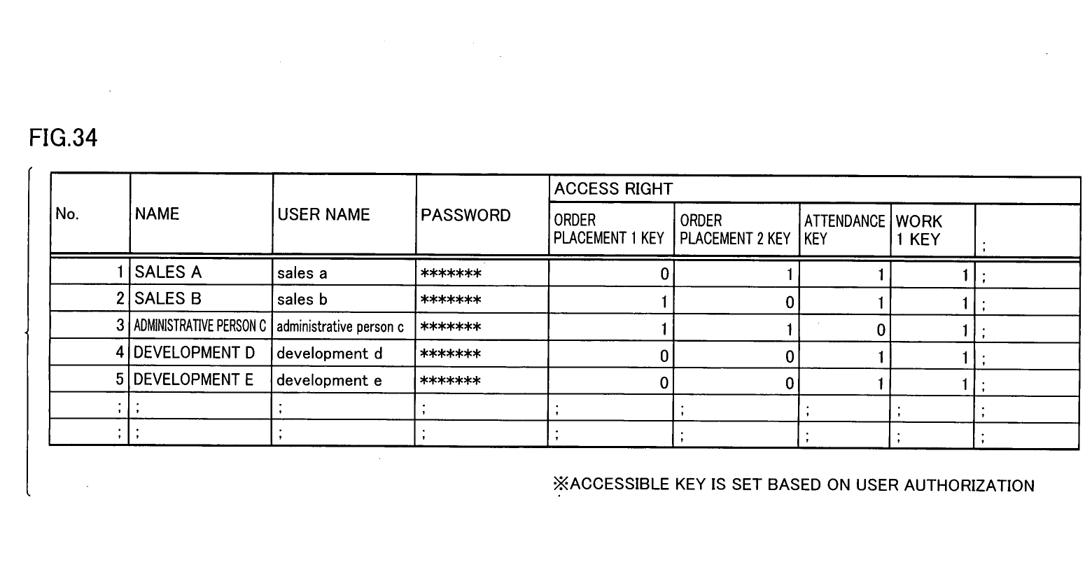

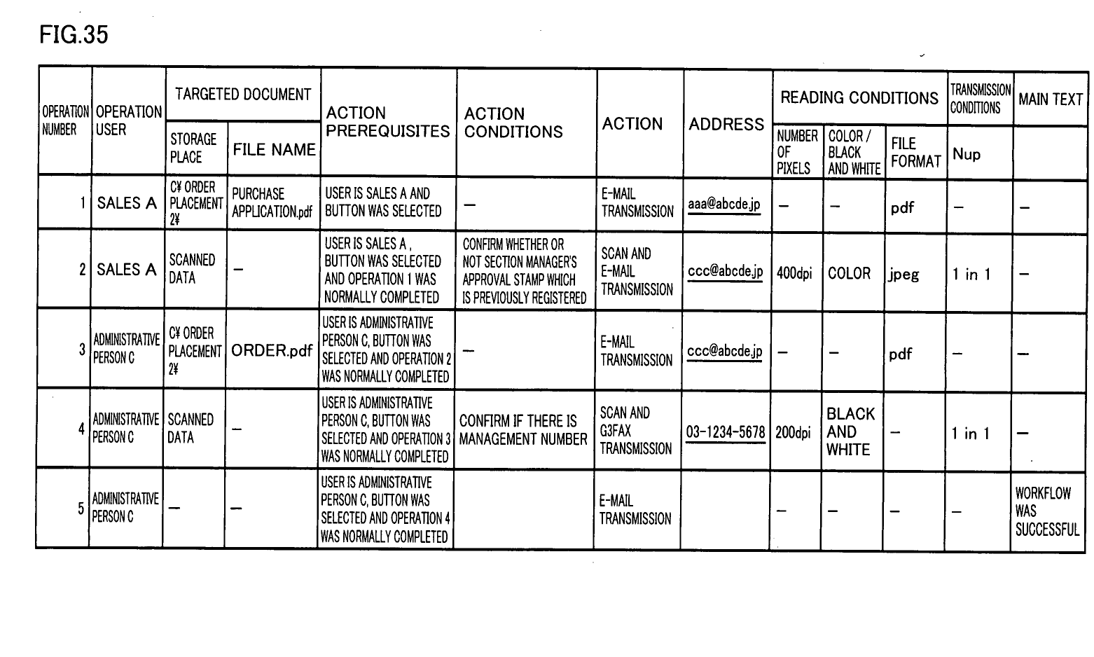

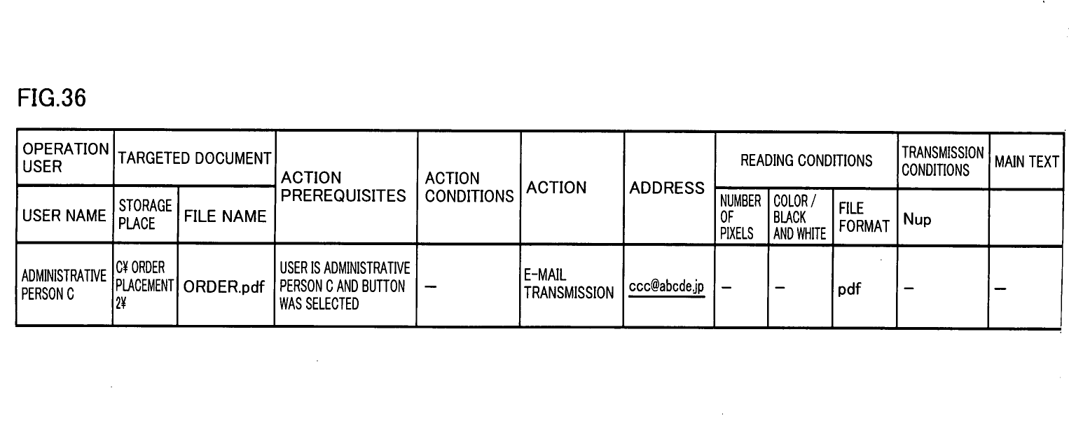

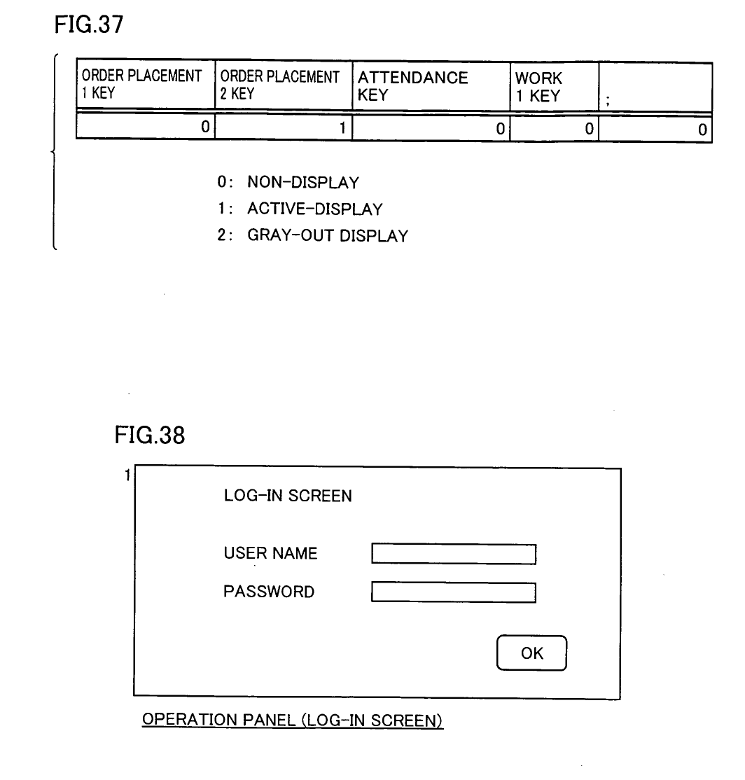

Setting information set by application software and operation panels 115 in each of the MFPs is stored in MFP control server 300. The setting information includes a user authentication table (see FIG. 34), address book, operation information per key (see FIG. 35. This information shows the operation information with respect to the workflow key), current operation information (see FIG. 36), key display flag information (see FIG. 37. This information shows the flag for displaying the key), and the like.

FIG. 34 shows a specific example of the user authentication table.

Referring to the drawing, the user authentication table is used for authentication of the user and management of an access right, wherein a name, a user name, a password and an access right are recorded in each registration number. In the column of the access right, the user having the access right is registered as “1” in each workflow.

FIG. 35 shows a specific example of the operation information.

The specific example shows the operation information for executing an operation similar to that of FIG. 4. The action conditions shown in the drawing include determination if the operation is executed by a legitimate operation user in addition to the conditions shown in FIG. 4.

FIG. 36 shows a specific example of the current operation information.

In the second preferred embodiment, the information of the operation currently being executed in FIG. 35 is recorded as the current operation information.

FIG. 37 shows a specific example of the key display flag information.

It is determined from the information of FIG. 37 if the key of each workflow is not displayed, active-displayed or gray-out displayed.

In the present preferred embodiment, the PC and the server are configured in a manner similar to those of FIG. 2, and the MFP is configured in a manner similar to that of FIG. 3.

An object of the present preferred embodiment is to realize the workflow which links an intra-company network and an inter-company network. In the present preferred embodiment, the workflow according to the first preferred embodiment is executed in the MFPs located at the different places. Sales A is in Osaka, while Administrative Person C is in Nagoya.

Sales A registers the key of the workflow to be operated from the application software for setting operation panel 115 of MFP and MFP in accordance with the workflow. The operation information (FIG. 35) is stored in MFP control server 300. When the user logs-in on operation panel 115 and selects the workflow key, MFP accesses MFP control server 300 to thereby obtain the operation information.

MFP executes the processing based on the obtained operation information, and displays the obtained information on operation panel 115.

FIGS. 38-41 respectively show specific examples of the display on operation panel 115.

As shown in FIG. 38, Sales A logs-in on a screen of MFP 100c in Osaka. MFP 100c in Osaka accesses MFP control server 300 to thereby inquire the access right. MFP control server 300 references the user authentication table (FIG. 34) and returns the key which Sales A is allowed to access.

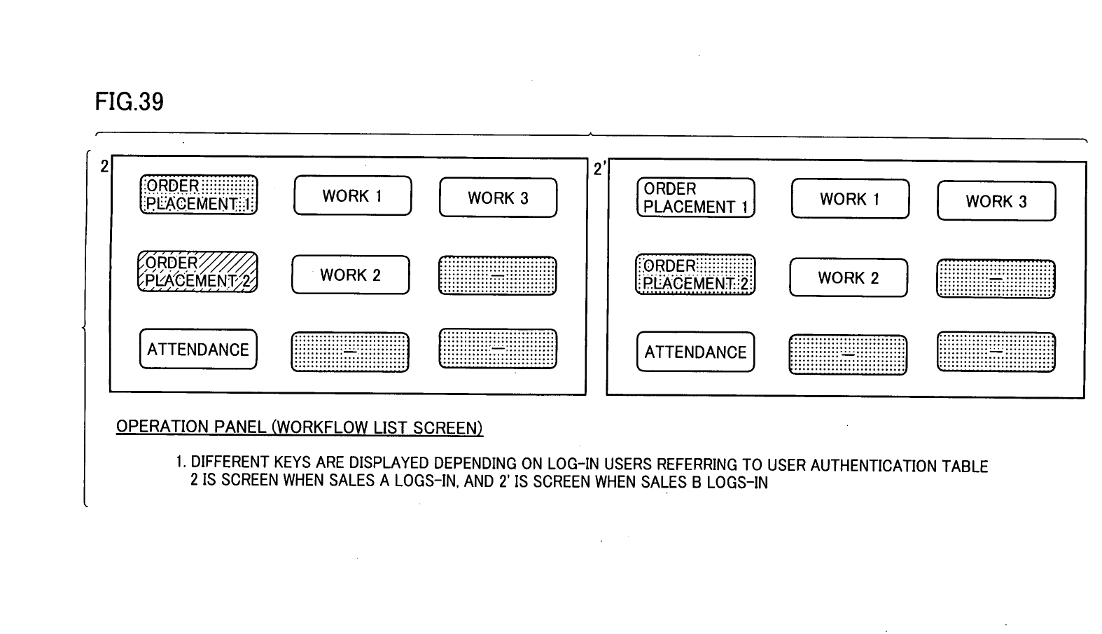

As shown in a left box shown in FIG. 39, MFP 300c in Osaka displays the obtained key on operation panel 115. A right box in FIG. 39 shows a screen when Sales B logs-in. When Sales B logs-in, the key which Sales B is allowed to access is displayed.

When Sales A selects the key of “order placement 2” on operation panel 115, MFP 100c in Osaka notifies MFP control server 300 of the selection.

MFP control server 300, in response to the reception of the notice, set the flag of the key of “order placement 2” in the key display flag information (FIG. 37) to “1”, and then, accesses the operation information in the memory (FIG. 35) to thereby store information executed subsequent to the current operation information (FIG. 36).

When the respective users log-in the respective MFPs on operation panels 115, MFPs obtain the operation information of the key of “order placement 2”, current operation information (FIG. 36) and key display flag information (FIG. 37) at certain time intervals to thereby decide the information to be displayed on their operation panels 115.

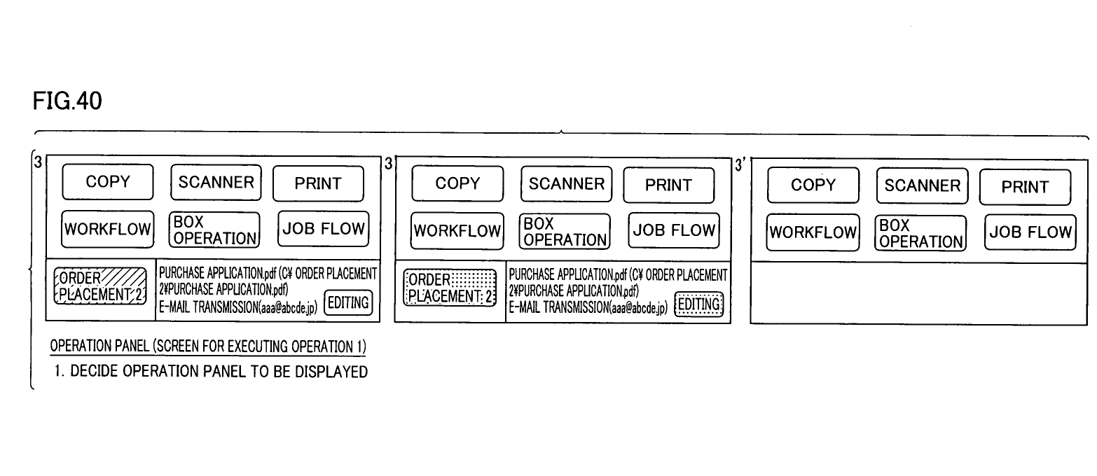

MFP 100c in Osaka displays a screen on left side shown in FIG. 4 to Sales A. When Administrative Person C logs-in MFP, MFP displays a screen at the center shown in FIG. 40 in accordance with the information from MFP control server 300. The key of “order placement 2” is displayed, however, displayed in the gray-out fashion and cannot be accessed. When any user other than Sales A and Administrative Person C logs-in, a screen on right side shown in FIG. 40 is displayed. Therefore, the information relating to “order placement 2” is not displayed.

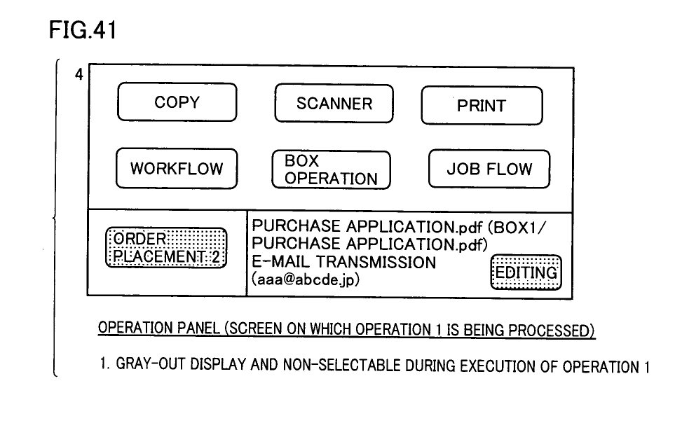

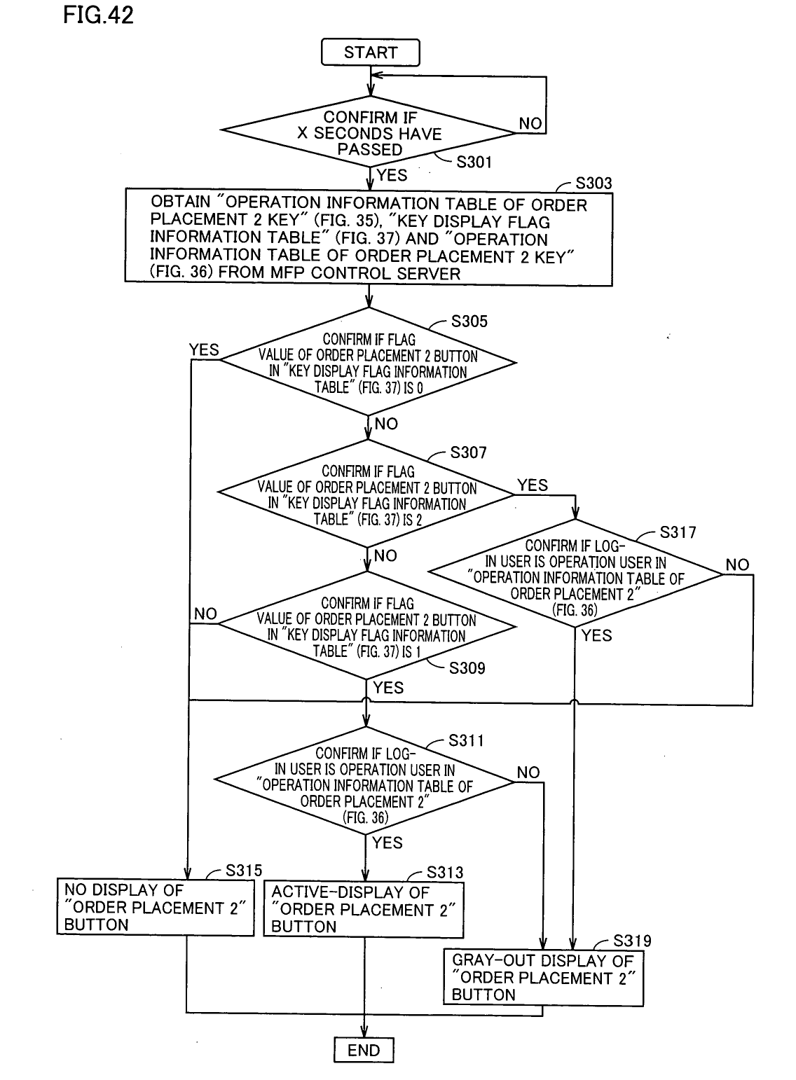

When Sales A selects the key of “order placement 2” on the right screen in FIG. 40, MFP 100c in Osaka notifies the MFP control server 300 of the selection. MFP control server 300, upon the notification of the selection of the key of “order placement 2”, sets the part of the key of “order placement 2” in the key display flag information shown in FIG. 37 to “2”. MFP 100c in Osaka obtains the key display flag information (FIG. 37) from MFP control server 300, and displays a screen shown in FIG. 41 on operation control panel 115.

When MFP 100c in Osaka terminates the operation of one step, MFP control server 300 is notified of the termination. MFP control server 300 accesses the operation information (FIG. 35), stores information executed subsequent to the current operation information (FIG. 36), and sets the part of the key of “order placement 2” in the key display flag information shown in FIG. 37 to “1”. Such a processing is repeatedly executed until the registered operations are completed.

When the editing key is pressed in operation panel 115 of MFP, the current operation information stored in MFP is overwritten as set. When the OK key is pressed, the operation is executed with reference to the current operation information. When the operation result shows an error, MFP displays the error screen on operation panel 115. When the OK key is selected by the user on the error screen, the failed operation is displayed on the top screen so that redo of the operation is encouraged. When the end key is selected, MFP control server 300 is notified of the failure.

MFP control server 300, upon the reception of the failure result from MFP, deletes the current operation information (FIG. 36), and sets the flag of the key of “order placement 2” in the key display flag information (FIG. 37) to “0”, and notifies each device of termination of the workflow. MFP, which is notified of the termination by MFP control server 300, deletes the memorized operation information of the key of “order placement 2 (FIG. 35), current operation information (FIG. 36) and key display flag information (FIG. 37), and displays the top screen.

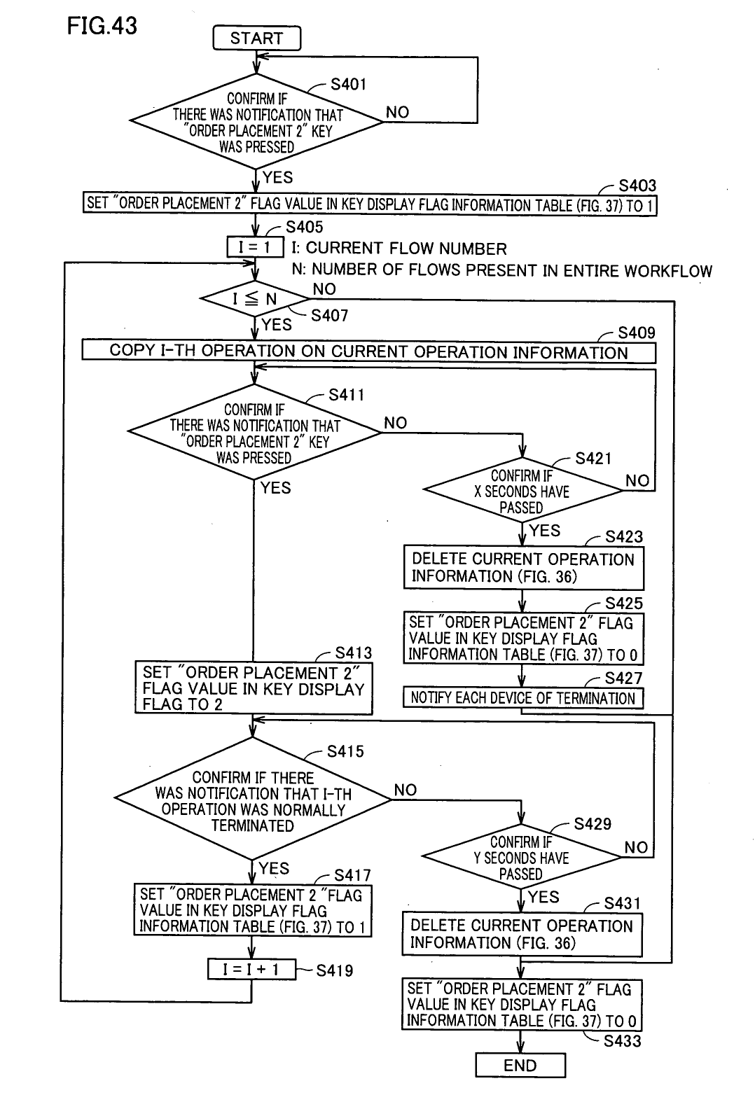

FIG. 42 is a flow chart illustrating the top screen display processing executed by MFP.

Referring to the drawing, it is determined in step S301 if a predetermined amount of time has passed. When the determination result shows YES, the operation information of the key of “order placement 2” (FIG. 35), current operation information (FIG. 36) and key display flag information (FIG. 37) are obtained from MFP control server 300 in step S303. It is determined in step S305 if the flag value of the key of “order placement 2” in the key display flag information (FIG. 37) is “0”. When the determination result shows YES, the key of “order placement 2” is not displayed in step S315.

When the determination result shows NO in step S305, it is determined in step S307 if the flag value of the key of “order placement 2” in the key display flag information (FIG. 37) is “2”. When the determination result shows YES, it is determined in step S317 if the log-in user is the operation user in the operation information of the key of “order placement 2” (FIG. 36). When the determination result shows YES, the key of “order placement 2” is displayed in the gray-out fashion in step S319. When the determination result shows NO, the key of “order placement 2” is not displayed in step S315.

When the determination result shows NO in step S307, it is determined if the flag value of the key of “order placement 2” in the key display flag information (FIG. 37) is “1” in step S309. When the determination result shows YES, it is determined if the log-in user is the operation user in the operation information of the key of “order placement 2” (FIG. 36) in step S311. When the determination result shows YES, the key of “order placement 2” is active-displayed in step S313.

When the determination result shows NO in step S311, the key of “order placement 2” is displayed in the gray-out fashion in step S319.

FIG. 43 is a flow chart illustrating the processing executed by MFP control server 300.

It is determined in step S401 if there was a notification that the key of “order placement 2” was pressed from MFP. When the determination result shows YES, the flag of “order placement 2” in the key display flag information (FIG. 37) is set to “1” (active-display) in step S403.

“1” is assigned to the variable showing the current flow number in step S405.

It is determined in step S407 if the number of the flows present in the entire work flow is at most N. The processing proceeds to step S409 when the determination result shows YES, while proceeding to step S433 when NO. In FIG. 35, N is five.

In step S409, the operation of the I-th operation number is copied on the current operation information (FIG. 36). Then, it is determined in step S411 if there was the notification that the key of “order placement 2” was pressed from MFP. When the determination result shows YES, the flag of “order placement 2” in the key display flag information (FIG. 37) is set to “2” (gray-out display) in step S413.

It is determined in step S415 if there was a notification that the I-th operation was normally terminated from MFP. When the determination result shows YES, the flag of “order placement 2” in the key display flag information (FIG. 37) is set to “1” (active-display) in step S417. Then, the value of I is 1-incremented in step S419, and the processing returns to step S407.

When the determination result shows NO in step S411, it is determined in step S421 if a predetermined amount of time has passed. The processing returns to step S411 when the determination result shows NO, while the current operation information (FIG. 36) is deleted in step S423 when YES. Then, in step S425, the flag of the key of “order placement 2” in the key display flag information (FIG. 37) is set to “0” (non-display), and the termination of the workflow is informed to each device such as MFP in step S427. Thereafter, the flag of the key of “order placement 2” in the key display flag information (FIG. 37) is set to “0” (non-display) in step S433.

When the determination result shows NO in step S415, it is determined in step S429 if a predetermined amount of time has passed. The processing returns to step S415 when the determination result shows NO, while the current operation information (FIG. 36) is deleted in step S431 when YES. Then, the processing proceeds to step S433.

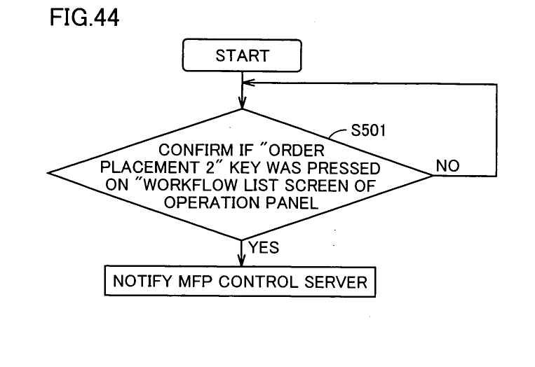

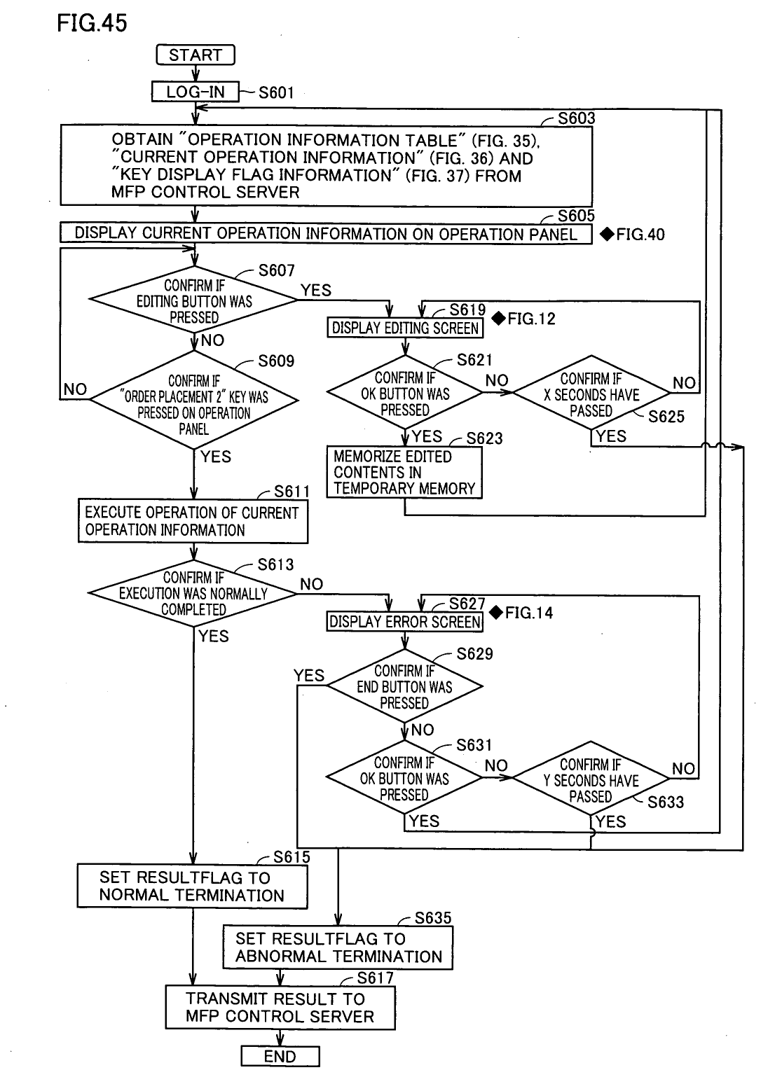

FIG. 44 is a flow chart illustrating the processing executed by MFP.

As shown in the drawing, in the case where the key of “order placement 2” is pressed on the workflow list screen of operation panel 115 in step S501, MFP control server 300 is notified that the key was pressed.

FIG. 45 is a flow chart illustrating the processing executed by MFP when the order placemen key is pressed on the top screen of MFP.

Referring to the drawing, the user log-in processing is executed in step S601. In step S603, the operation information of the key of “order placement 2” (FIG. 35), current operation information (FIG. 36) and key display flag information (FIG. 37) are obtained from MFP control server 300.

In step S605, the current operation information is displayed on the top panel.

It is determined if the editing key was pressed in step S607. When the determination result shows YES, the editing screen is displayed in step S619. It is determined if the OK key was pressed in step S621. When the determination result shows YES, the edited contents are memorized in temporary memory 107 in step S623, and the processing returns to step S603.

When the determination result shows NO in step S621, it is determined if a predetermined amount of time has passed in step S625. The processing returns to step S619 when the determination result shows NO, while proceeding to step S635 when YES.

When the determination result shows NO in step S607, it is determined in step S609 if the key of “order placement 2” was pressed on the top screen. The processing proceeds to step S607 when the determination result shows NO, while proceeding to step S611 when YES.

The operation of the current operation information is executed in step S611. Details of this processing are the same as in the description in the flow chart shown in FIG. 31.

Then, it is determined in step S613 if the processing was normally terminated. When the determination result shows YES, ResultFlag is set to normal termination in step S615, and the result is transmitted to MFP control server 300 in step S617.

When the determination result shows NO in step S613, the error screen is displayed in step S627. It is determined in step S629 if the end key was pressed. It is determined in step S631 if the OK key was pressed when the determination result shows NO, while the processing returns to step S603 when YES.

When the determination result shows NO in step S631, it is determined if a predetermined amount of time has passed in step S633. The processing returns to step S627 when the determination result shows NO, while proceeding to step S635 when YES.

In step S635, ResultFlag is set to abnormal termination, and the processing proceeds to step S617.

In the second preferred embodiment, MFP control server was used. However, the function of the MFP control server may be covered by any of the MFPs so that a system where the MFP control server is not provided is also capable of executing the processings.

### EFFECTS OF THE PREFERRED EMBODIMENTS

As described thus far, the successive operations, which conventionally could not be set as a workflow, can be as a program key (workflow key) and the set program key is pressed so that the steps of the workflow can be serially executed.

Further, when one key (one key displayed in the different MFPs in the second preferred embodiment) is pressed, the workflow can be serially executed, which improves the user's easiness-to-handle.

Further, the key of the workflow to be processed by the log-in user is automatically displayed depending on the log-in processing and the progress the workflow. Therefore, the user can easily grasp the job to be done by him/herself, which improves an efficiency in the execution of the operations.

Further, the editing key in part of the workflow is provided. In the case where, for example, the address registered in the workflow cannot be used for the transmission (PC goes down, or the like), the user can input a different address when the error indicating that the address is not available is displayed on the operation panel.

### Others

The progress of the workflow may be displayed on the operation panel. More specifically, the display may show which of the steps in the entire workflow is being executed, and how many steps have been executed.

The processings according to the preferred embodiments may be executed on software or a hardware circuit.

A program for executing the processings in the flow charts according to the preferred embodiments may be provided. Further, the program may be recorded in a recording medium such as CD-ROM, flexible disc, hard disc, ROM, RAM and memory card, and then, supplied to the user. The program may be downloaded into the device via a communication line such as internet.

The present invention can be applied to a system which is connected to a network environment and a system which is not connected to the network.

While there has been described what is at present considered to be the preferred embodiments of the present invention, it will be understood that various modifications may be made therein, and it is intended to cover in the appended claims and the meaning and scope of equivalence all such modifications as fall within the true spirit and scope of this invention.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image forming device capable of executing a workflow including a plurality of steps comprising:
a register unit for registering a key which instructs execution of said workflow; and
a control unit for executing a control processing for implementing the steps of said workflow when the key registered in said register unit is pressed.

2. The image forming device as claimed in claim 1, wherein
said register unit allocates the execution of the workflow to one key, and
said control unit executes one of the steps of the allocated workflow every time when said one key is pressed.

3. The image forming device as claimed in claim 1, wherein
operations of different types constitute the respective steps in said workflow.

4. The image forming device as claimed in claim 1, further comprising a display unit for displaying information relating to the steps to be executed.

5. The image forming device as claimed in claim 1, further comprising an accepting unit for accepting a change of a part of said workflow.

6. The image forming device as claimed in claim 1, further comprising a setting unit for setting a validity time limit with respect to each of the steps of said workflow.

7. The image forming device as claimed in claim 1, wherein
said key is displayed on the display unit, and
a method of displaying said key is changed based on processing contents and a processing status of said workflow.

8. The image forming device as claimed in claim 7, further comprising an identifying unit for identifying a user who uses the image forming device, wherein
said display unit changes the display of said key based on said identified user.

9. An image forming system comprising a plurality of image forming devices capable of executing a workflow including a plurality of steps connected to a network, wherein
said image forming device comprises:
a register unit for registering a key for instructing execution of said workflow; and
a control unit for executing a control processing for executing the steps of said workflow when the key registered in said register unit is pressed, wherein
said control processing for executing the steps of said workflow is executed by the control unit provided in any of the plurality of image forming devices for executing the respective steps.

10. The image forming system as claimed in claim 9, wherein
said register unit allocates the execution of the workflow to one key, and
said control unit executes one of the steps of the allocated workflow every time when said one key is pressed.

11. The image forming system as claimed in claim 9, wherein
operations of different types constitute the respective steps in said workflow.

12. The image forming system as claimed in claim 9, further comprising a server for managing said workflow.

13. A method of controlling an image forming device capable of executing a workflow including a plurality of steps, wherein
said image forming device registers a key which instructs execution of the workflow, and
the control method comprises steps of:
detecting that said registered key is pressed; and
executing a control processing for implementing the steps of said workflow when said registered key is pressed.

14. The method of controlling the image forming device as claimed in claim 13, wherein
the execution of the workflow is allocated to one key in said register step, and
one of the steps of the allocated workflow is executed every time when the one key is pressed in said control step.

15. The method of controlling the image forming device as claimed in claim 13, wherein
operations of different types constitute the respective steps in said workflow.

16. The method of controlling the image forming device as claimed in claim 13, further comprising a step of displaying information relating to the steps to be executed.

17. The method of controlling the image forming device as claimed in claim 13, further comprising a step of accepting a change of a part of said workflow.

18. The method of controlling the image forming device as claimed in claim 13, further comprising a step of setting a validity time limit with respect to each of the steps of said workflow.
